(19) United States
(12) Patent Application Publication
(10) Pub. No.: US 2004/0262487 A1
(43) Pub. Date: Dec. 30, 2004

(54) Base isolation device and method of installing base isolation device

(76) Inventors: Mitsuji Kawashima, Kashiwa-shi (JP); Tetsuo Nakamura, Abiko-shi (JP); Takumi Kikuchi, Abiko-shi (JP); Tamotsu Kohno, Iruma-gun (JP); Nobuo Hatano, Yashio-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/493,945

(22) PCT Filed: Oct. 28, 2002
(86) PCT No.: PCT/JP02/11137

(30) Foreign Application Priority Data
Oct. 29, 2001 (JP) 2001-331726
Oct. 29, 2001 (JP) 2001-331727
Jul. 3, 2002 (JP) 2001-195221

(51) Int. Cl. F16M 1/00

(52) U.S. Cl. 248/638

(57) ABSTRACT

This invention relates to a quake-absorbing device and installation method therefor.

A conventional quake-absorbing device has been known as described, for example, in Japanese Patent Application Public Disclosure No. 2000-14472(A).

This conventional quake-absorbing device comprises an upper base secured on an object to be protected from an earthquake or other vibrations, a lower base on a floor, upper and lower upcurved rails attached to the upper and lower bases, and rollers which moves rotatively along the upper and lower rails by rolling. The upper and lower rails are vertically opposed to each other across the rollers at the angle of approximately 90 degrees so as to be arranged in the plane form of a substantially square.

However, in a case where computer-associated equipment such as a computer server is protected from seismic waves, wiring such as communication and electric circuits is often laid on a floor and connected to the equipment. The wire or cable possibly comes into contact with the quake-absorbing device, consequently to degrade the quake-absorbing performance of the quake-absorbing device. Thus, it has been very difficult to apply the quake-absorbing device to the equipment having the wiring connected thereto.

To remedy the disadvantage suffered from the conventional quake-absorbing device, the present invention provides a quake-absorbing device having improved quake-absorbing performance and a method capable of installing the quake-absorbing device without suspending the operation of existing protected object.

The quake-absorbing device of the invention is distinctively provided with an opening passage for permitting the wiring cables connected to the protected object to pass therethrough so as not to bring the wiring cables into contact with the quake-absorbing device, thereby to achieve high quake-absorbing performance.

### TECHNICAL FIELD

This invention relates to a quake-absorbing device and installation method therefor.

### BACKGROUND ART

For example, Japanese Patent Application Publication No. 2000-14472 discloses a quake-absorbing device comprising an upper base attached to an object to be protected from an earthquake, a low&r base fixed on a floor, upcurved and downcurved rails placed between the upper and lower bases, and rollers movable rotatively along the rails. The upper and lower rails are vertically opposed to each other across the rollers at the angle of approximately 90 degrees so as to be arranged in the plane form of a substantially square.

When this conventional quake-absorbing device detects horizontal vibrations, the rollers ascend and traverse the curved surface of the upcurved rails (under the own weight of the protected object) to absorb the horizontal vibrations. Thus, the up-and-down movement of the rollers serves to absorb and damp seismological vibrations.

However, where the object to be protected from an earthquake is computer equipment such as computer servers, wiring laid on a floor for communication network is often connected to the protected object. In the conventional quake-absorbing device noted above, the wiring should inconveniently fit through between the rollers and rails.

Even if the protected object is subject to vibrations within the limits of allowing the quake-absorbing device to move from side to side, the wiring connected to the protected object is likely to be in touch with the components of the quake-absorbing device, consequently to degrade the quake-absorbing performance of the device. As a result, the conventional quake-absorbing device may not be available practically in many instances. Moreover, since the rails and rollers are immovably arranged with two tiers, the setting space between the protected object and floor is increased in elevation, but not quite as wide as to install the wiring with ease. When the protected object is used as a display case for articles of value, the conventional quake-absorbing device has similar difficulties in wiring.

Furthermore, when applying the conventional quake-absorbing device to an existing object to be protected from an earthquake, it requires troublesome works to temporarily suspend the service associated with the protected object in order to disconnect the wiring and then connect the wiring.

Thus, it is difficult to apply the conventional quake-absorbing device to the existing protected object. Such being the case, the existing protected object is fixedly secured to the floor by use of anchor members or the like in practice.

Even if the protected object is fixedly secured, the strength to protect the protected object from a fall has its limits when under vibration or shock of an earthquake.

Therefore, it is imperative to install a quake-absorbing device capable of absorbing or deadening the vibrations or shocks of the earthquake.

The conventional quake-absorbing device noted above necessitates a sufficient length of rails along which the rotating rollers move rotatively back and forth to effectively absorb or damp the vibrations of the earthquake. Consequently, the conventional quake-absorbing device is restricted in size by the length of the rails and difficult to be made smaller than the total length of the two rails. As a result, the conventional quake-absorbing device noted above lacks versatility.

The present invention is made in the light of the foregoing problems and aims at providing a quake-absorbing device capable of stably providing better quake-absorbing performance for a protected object having wiring arrangement connected thereto and being applied to the protected object in existence without suspending operation of the protected object, and an installation method for installing the quake-absorbing device.

### DISCLOSURE OF THE INVENTION

To eliminate the problems described above according to the present invention, there is provided a quake-absorbing device and installation method therefor, which are featured in that wiring arrangement connected to a protected object has an opening or passage for allowing wiring cables to pass therethrough.

The quake-absorbing device of the invention has a beneficial quake-absorbing effect without bringing the wiring cables into contact with the quake-absorbing device.

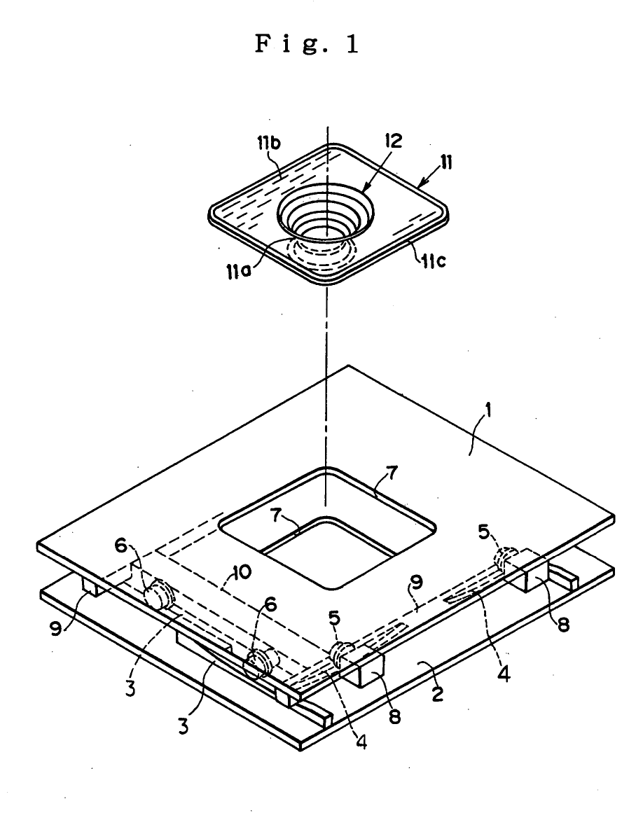

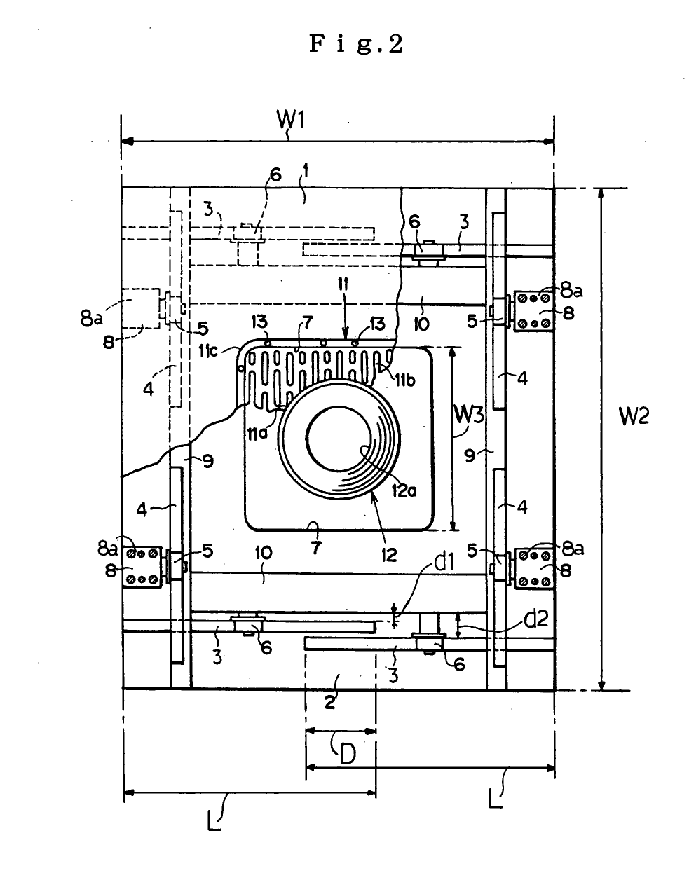

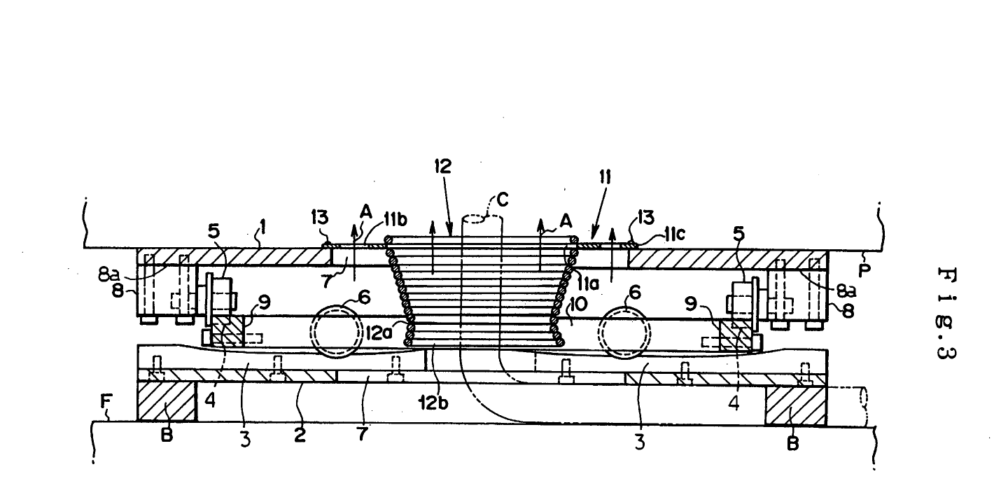

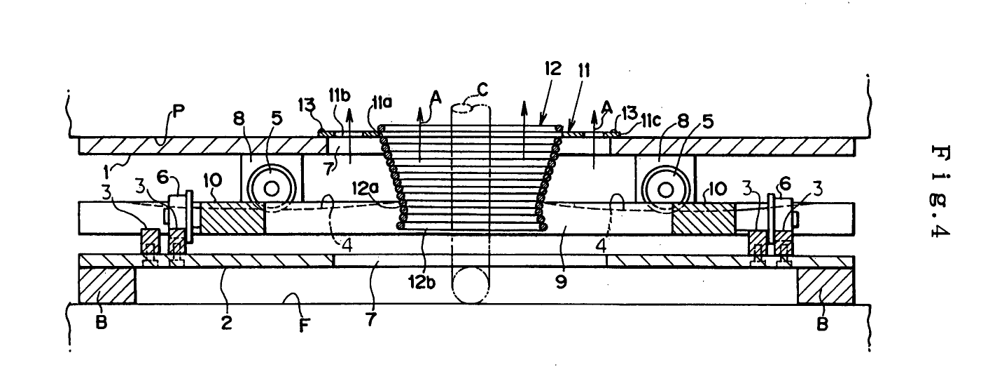

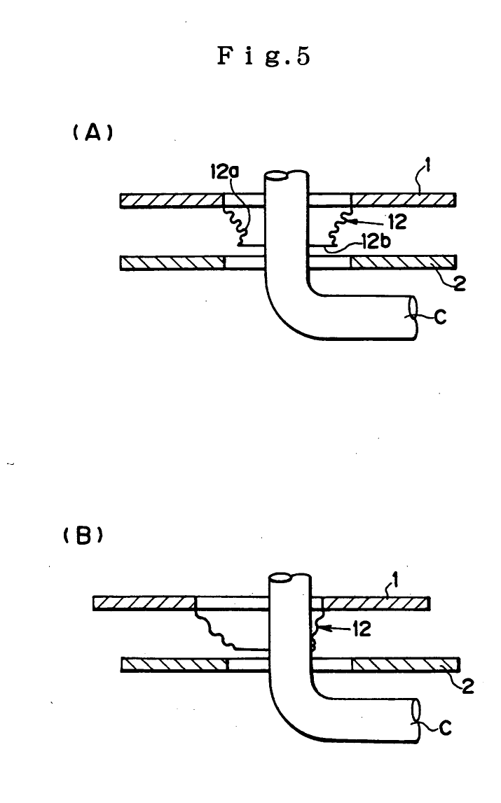

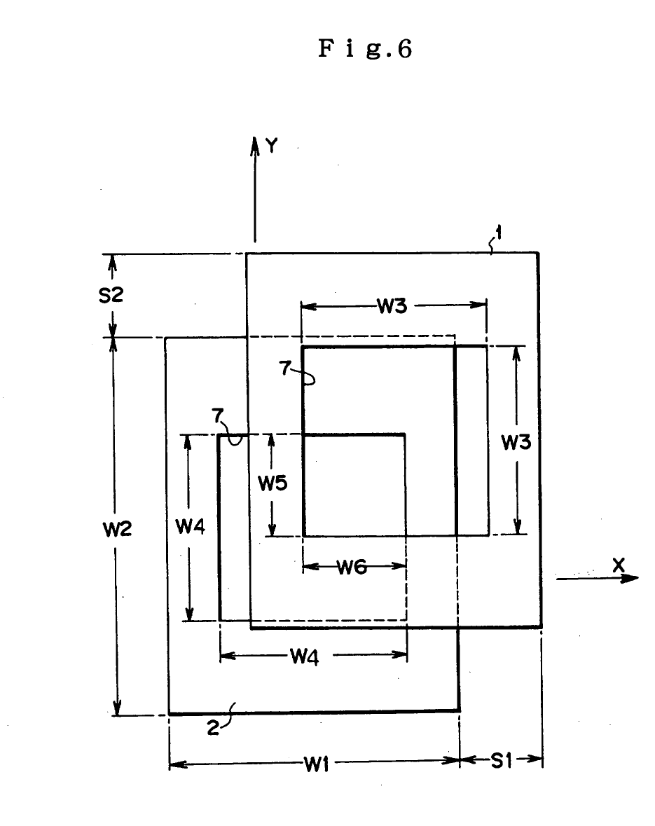

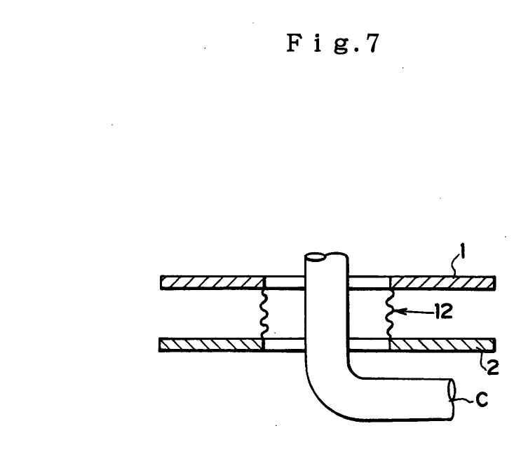

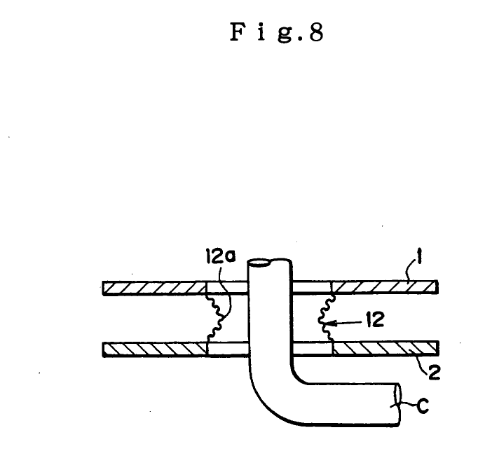

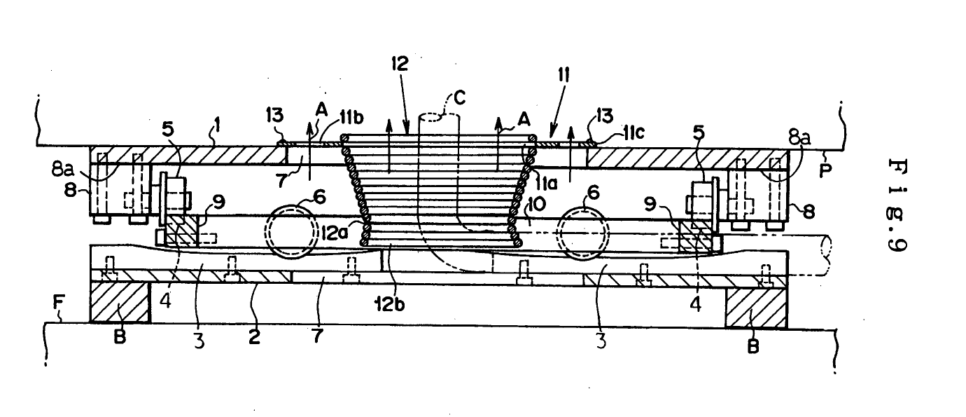

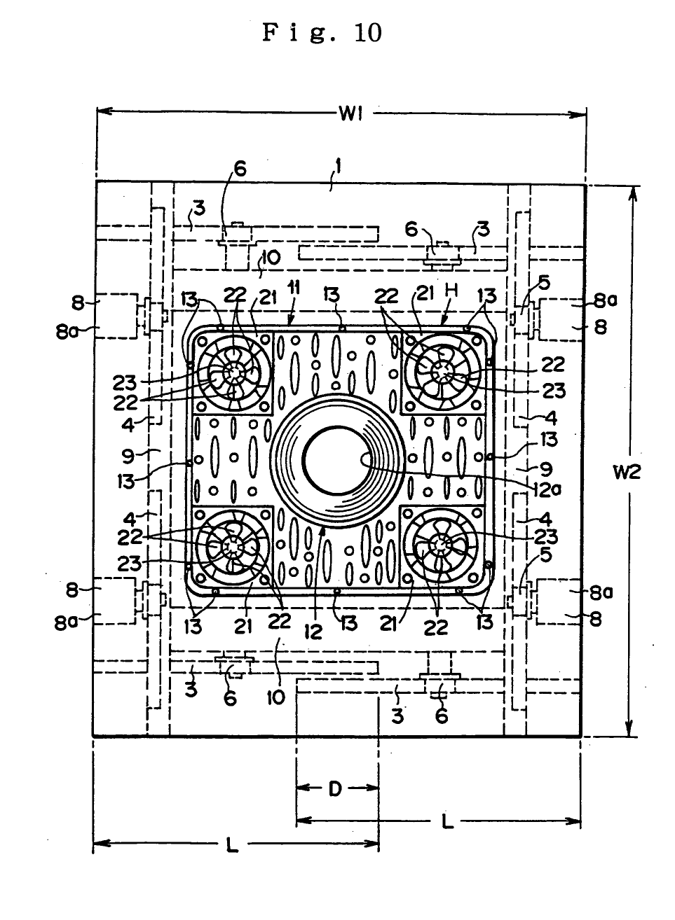

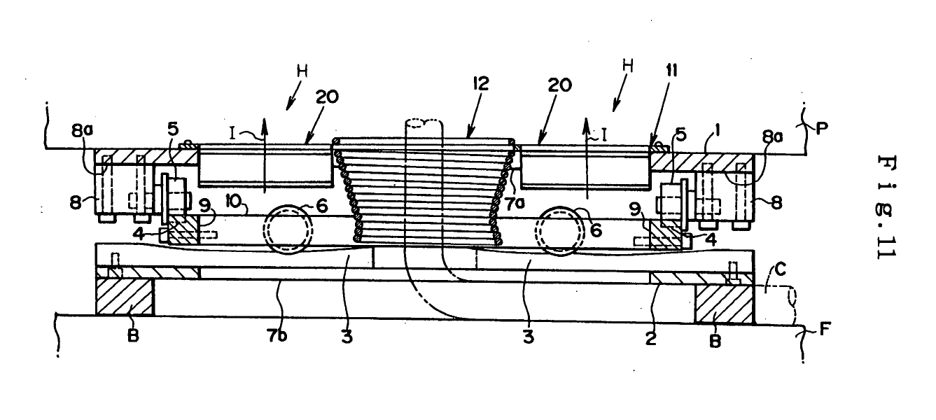

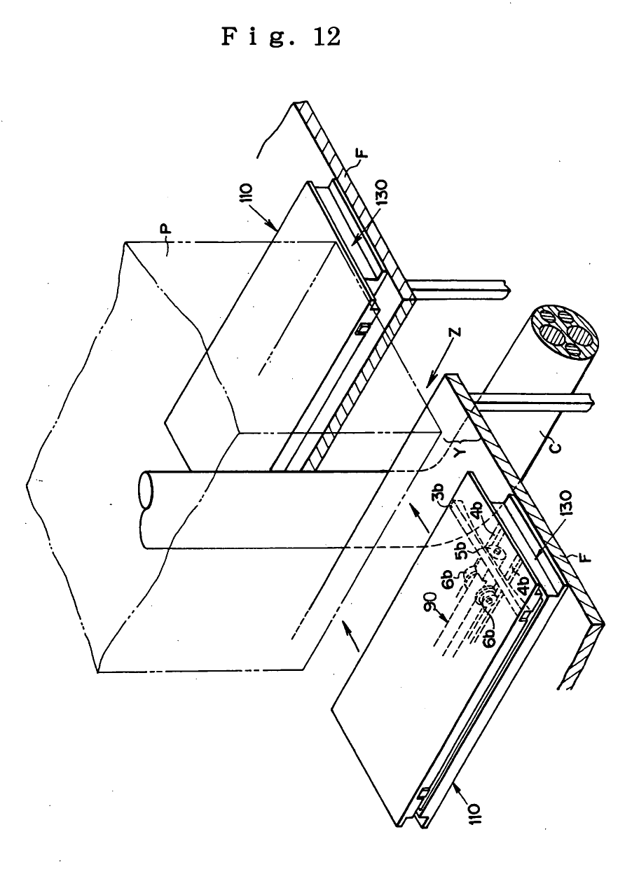

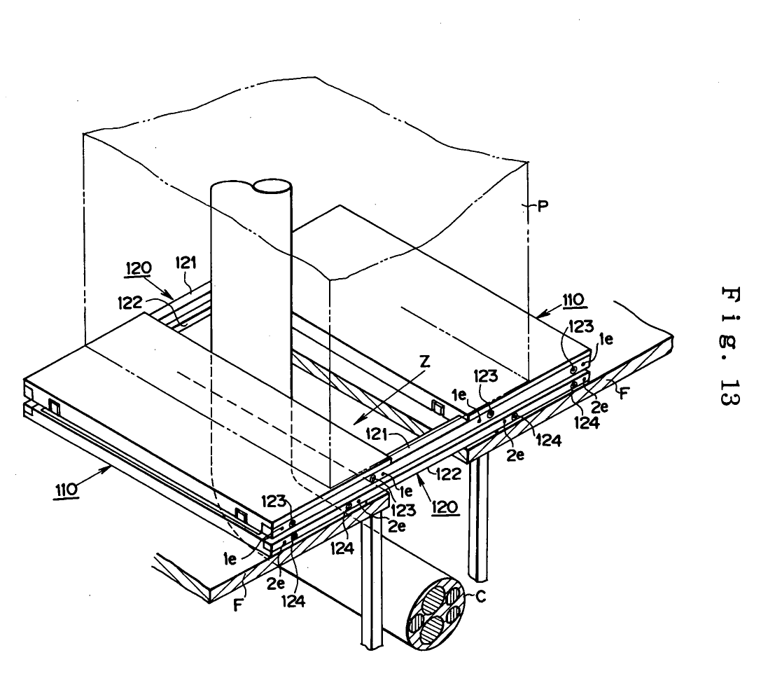

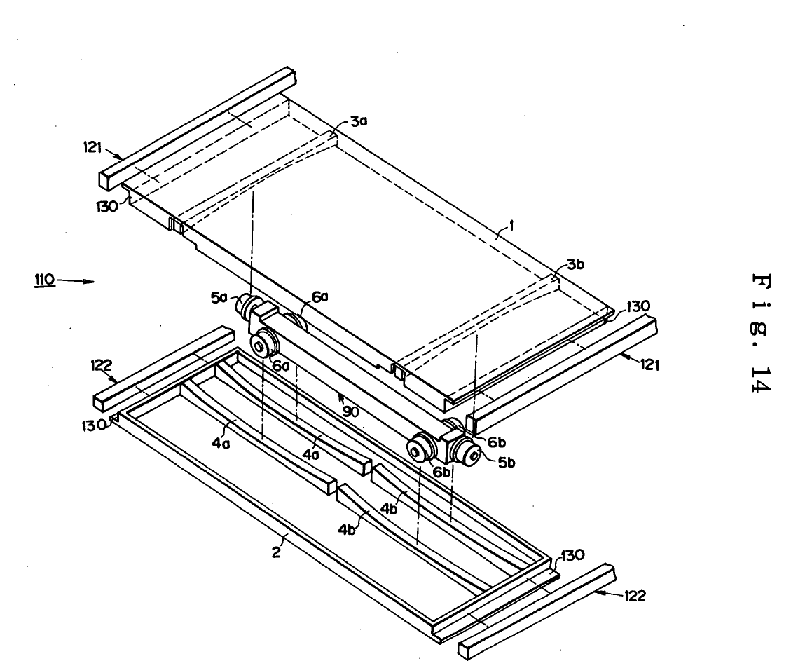

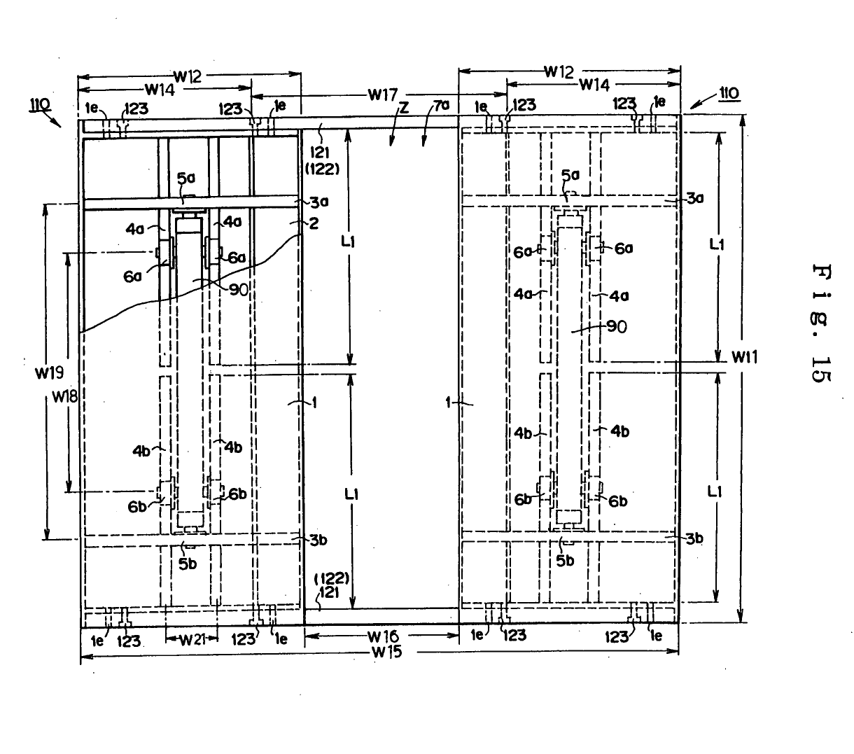

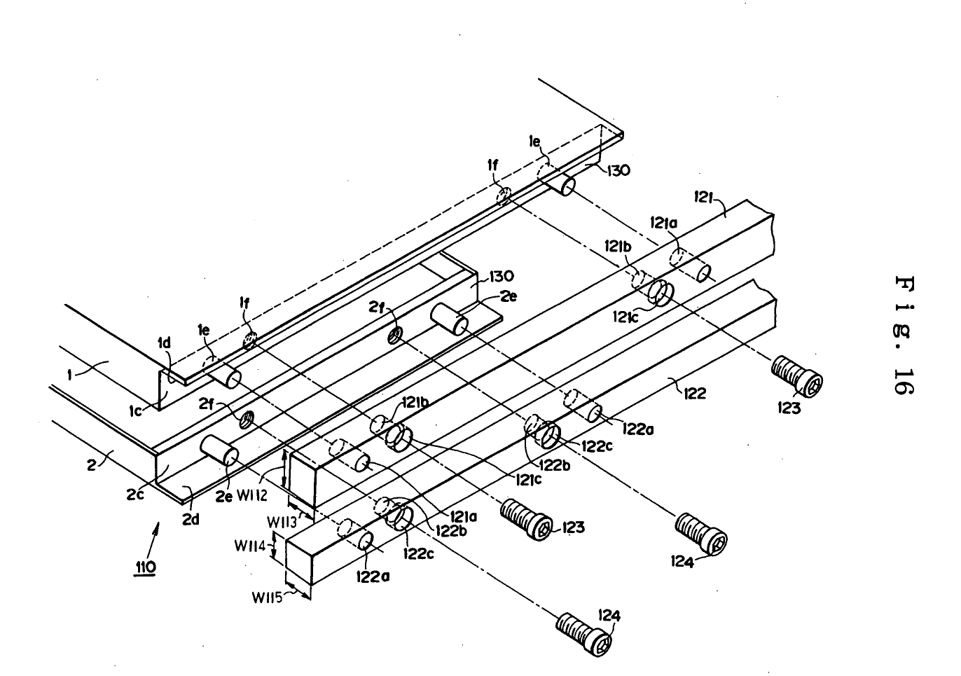

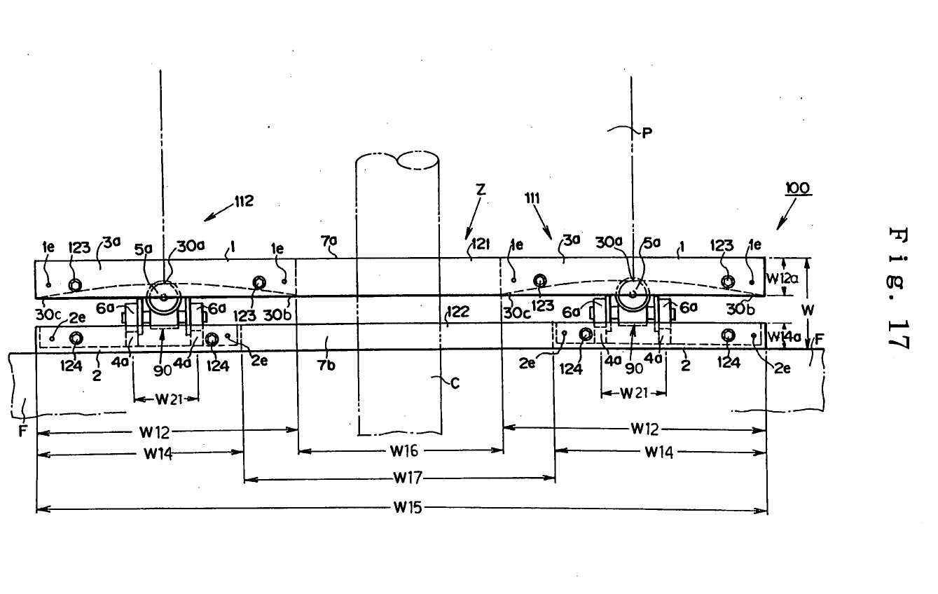

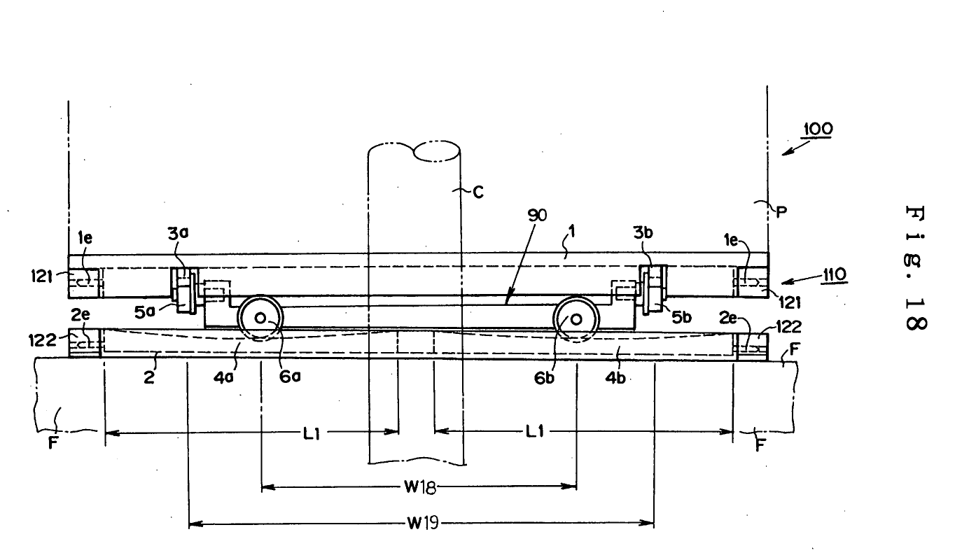

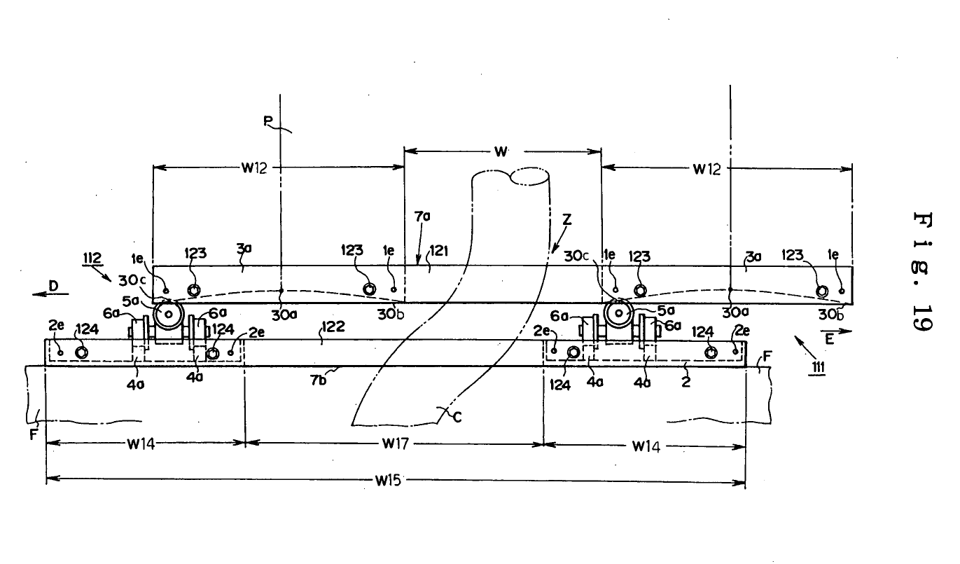

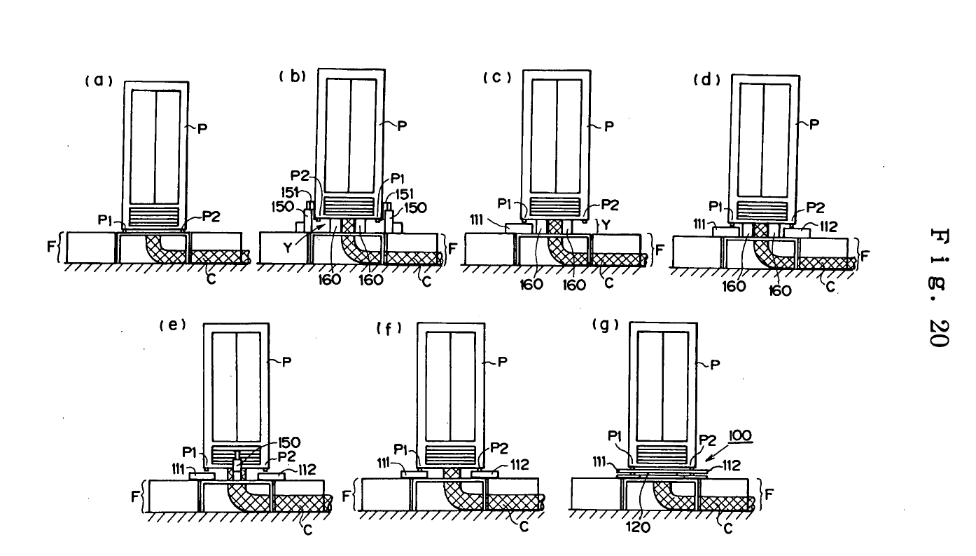

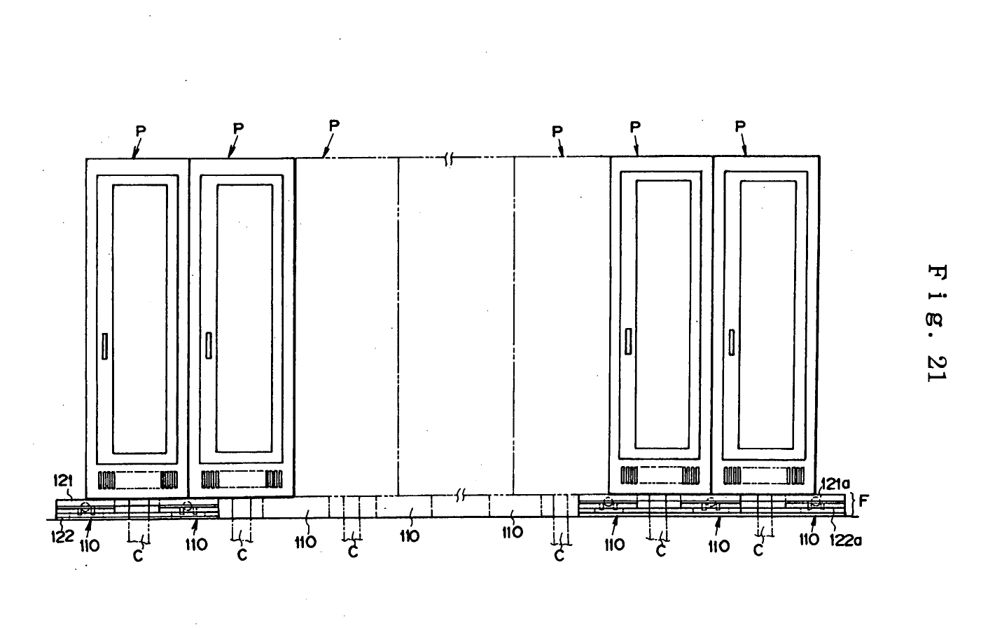

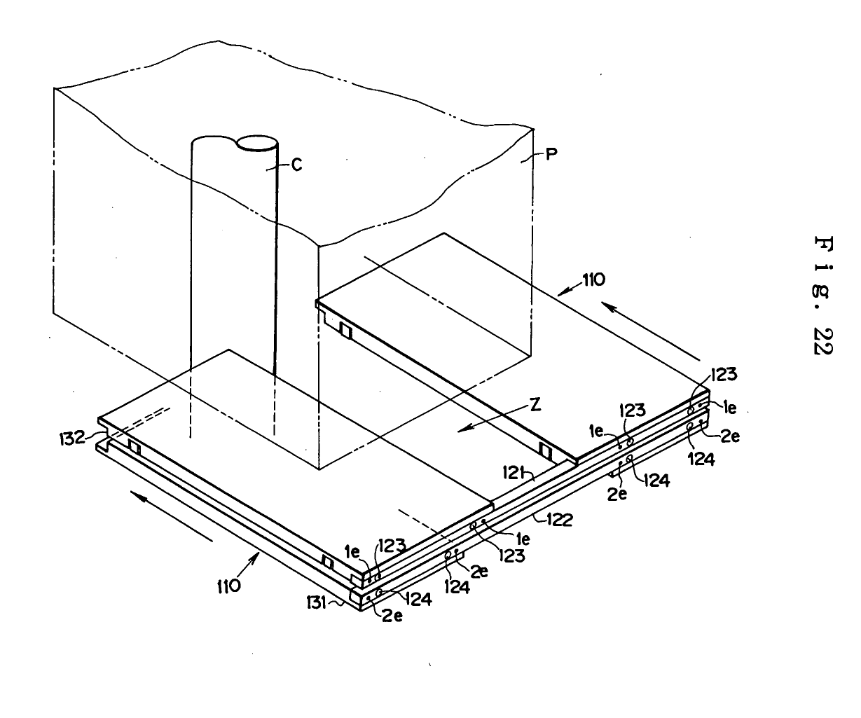

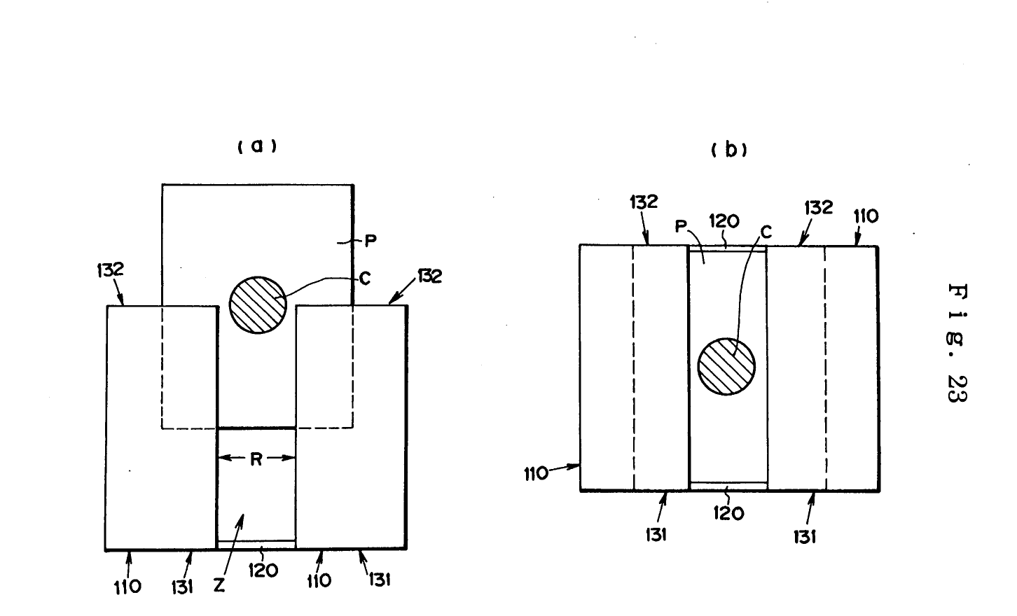

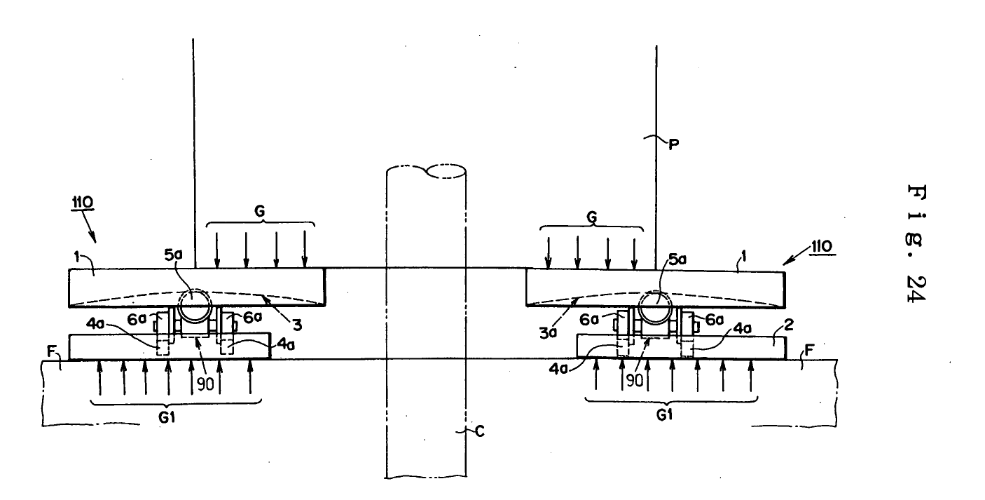

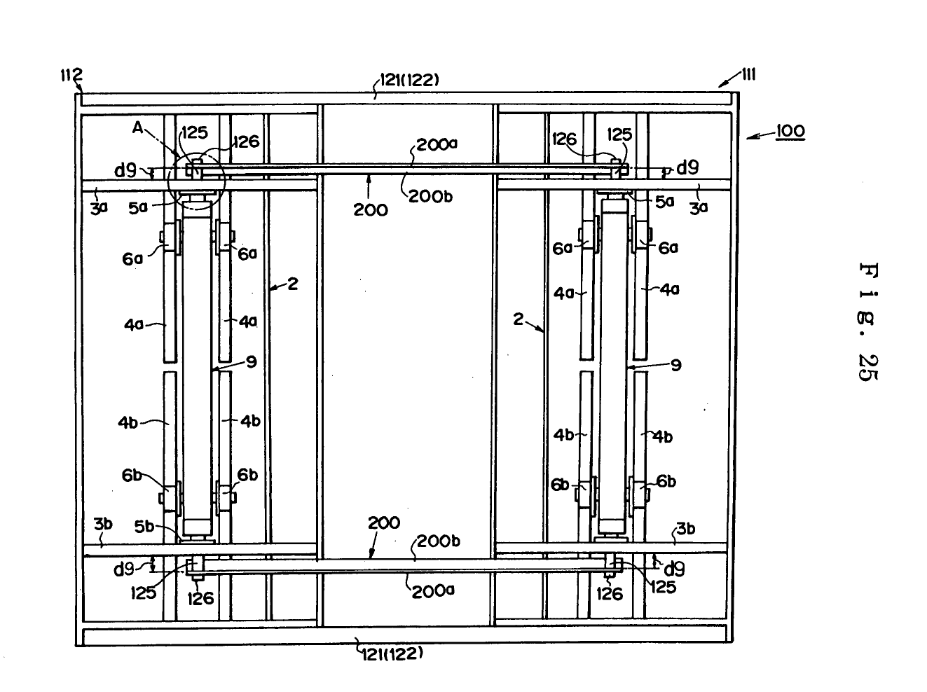

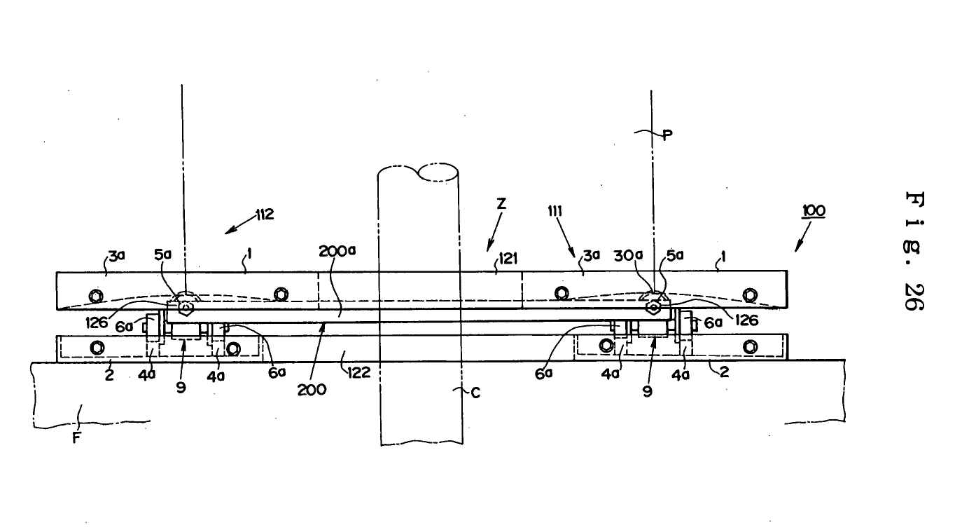

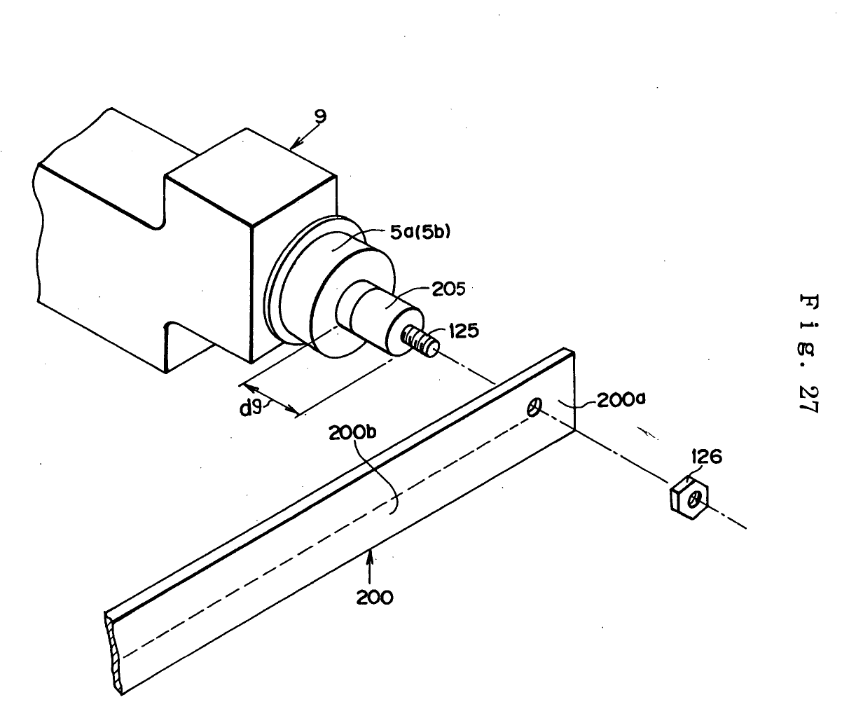

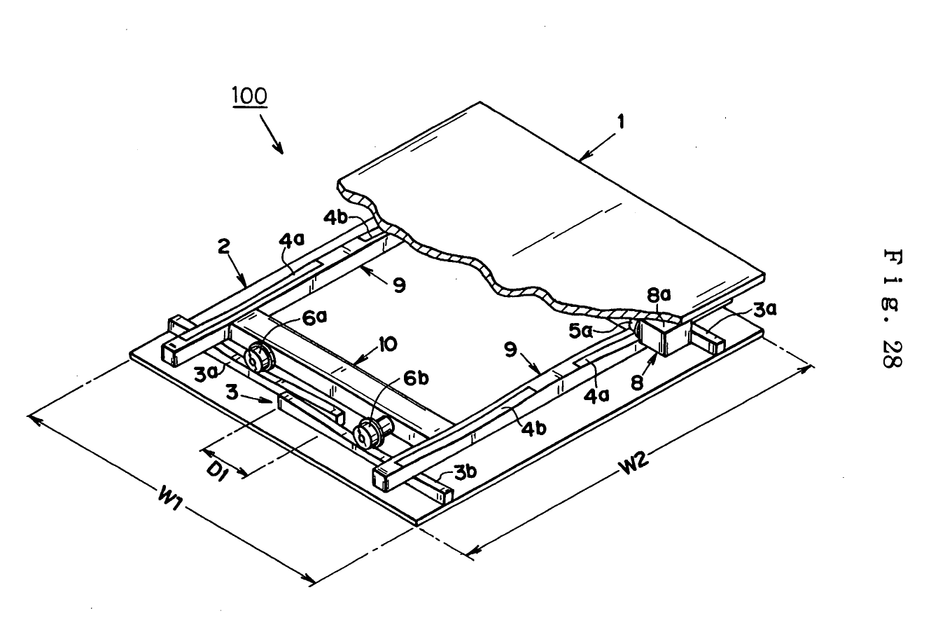

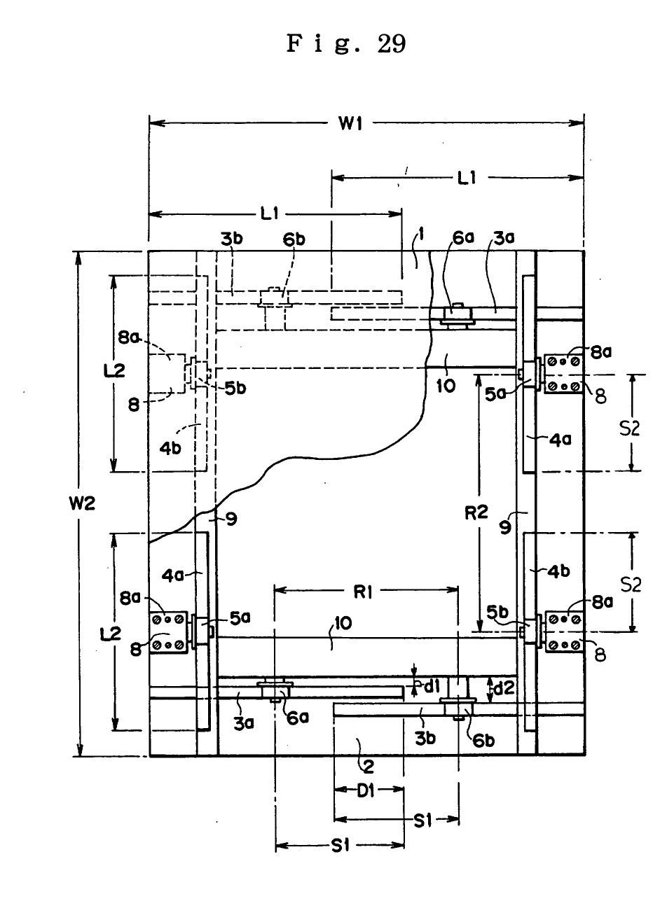

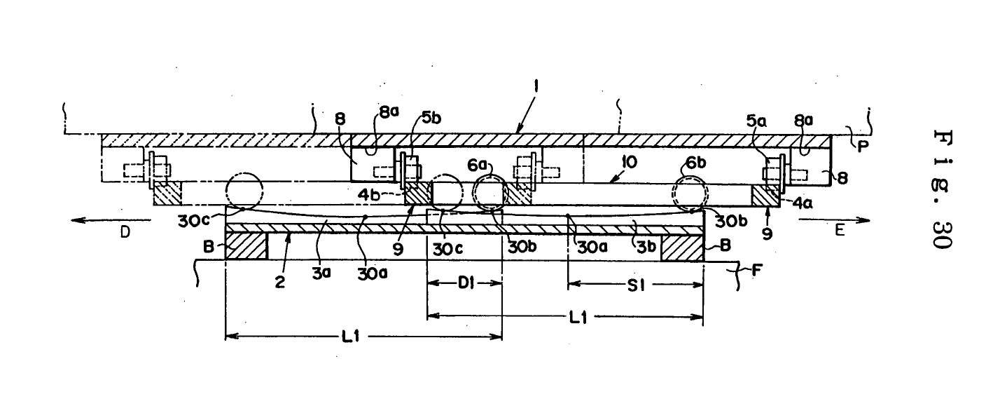

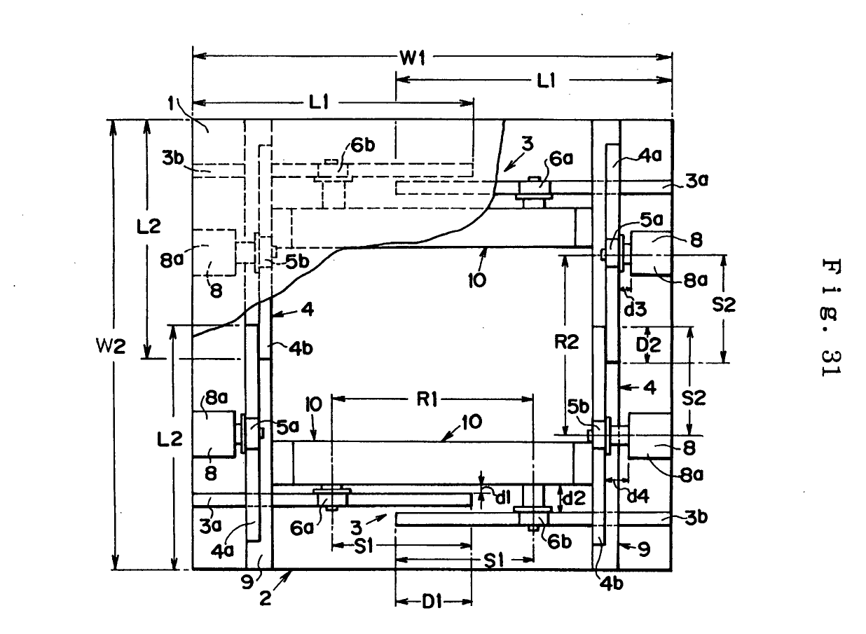

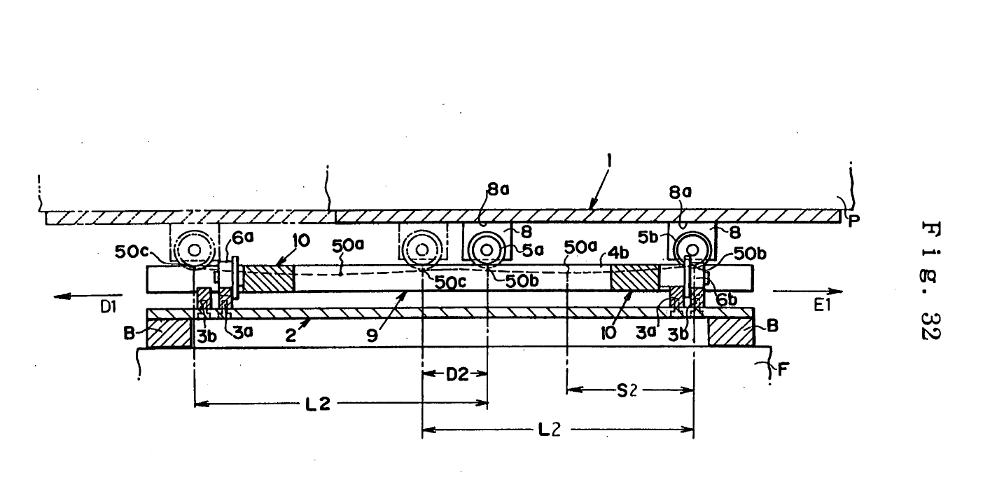

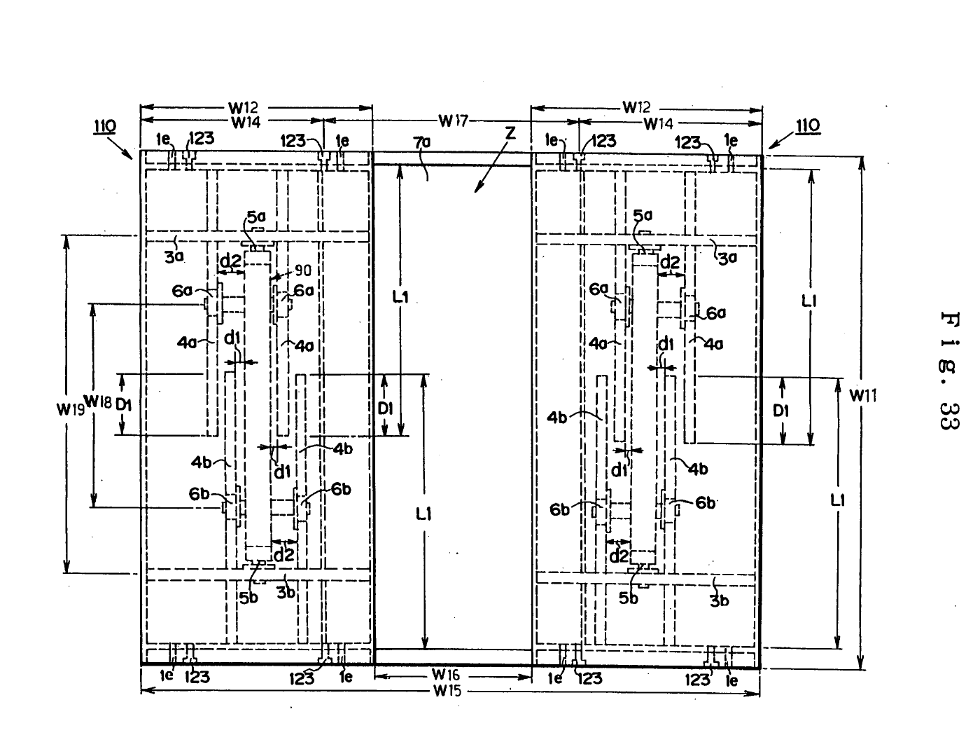

### BRIEF DESCRIPTION OF THE DRAWINGS

[FIG. 1] Exploded perspective view showing the quake-absorbing device in the preferred mode (1) for working the first invention.

[FIG. 2] Plan view, partly in section, showing the assembled state of the quake-absorbing device of FIG. 1.

[FIG. 3] Longitudinal sectional view taken along the center of the installed device of FIG. 2.

[FIG. 4] Longitudinal sectional view orthogonal to FIG. 3 and taken along the center of the installed device of FIG. 2.

[FIG. 5] Schematic diagrams showing the operation of the device shown in FIG. 3 and FIG. 4, wherein (A) shows the normal state of the device, and (B) shows the quake-absorbing state of the device.

[FIG. 6] Schematic diagrams showing the operation of the device shown in FIG. 3 and FIG. 4, schematically showing, in plane, the positional relationship of a wiring opening during quake-absorbing operation.

[FIG. 7] Schematic sectional view showing the quake-absorbing device of the second mode (2) for working the first preferred embodiment of the present invention.

[FIG. 8] Schematic sectional view showing the quake-absorbing device of the third mode (3) for working the first preferred embodiment of the present invention.

[FIG. 9] Schematic sectional view showing the quake-absorbing device of the fourth mode (4) for working the first preferred embodiment of the present invention.

[FIG. 10] Schematic sectional view showing the quake-absorbing device of the fifth mode (5) for working the first preferred embodiment of the present invention.

[FIG. 11] Longitudinal sectional view taken along the center of the installed device of FIG. 10.

[FIG. 12] Perceptive view showing the quake-absorbing device in another preferred embodiment for working the second invention.

[FIG. 13] Perspective view showing the quake-absorbing device in the installed state in another preferred embodiment for working the second invention.

[FIG. 14] Perspective view showing the quake-absorbing device of the sixth mode (6) for working the second embodiment of the present invention.

[FIG. 15] Plan view showing the device of FIG. 12 in the preferred embodiment for working the second invention.

[FIG. 16] Enlarged view showing the principal portion of the joint portion of a quake-absorbing unit and a connection member in the device of FIG. 12.

[FIG. 17] Side view of FIG. 12.

[FIG. 18] Side view of FIG. 12.

[FIG. 19] Side view showing the quake-absorbing device during quake-absorbing operation

[FIG. 20] Plan views showing the manner of installing the quake-absorbing device, wherein the processes of operation of the device are illustrated in (a)-(g) in order.

[FIG. 21] View showing the quake-absorbing device installed for a plurality of protected objects. [FIG. 22] Perspective view showing the quake-absorbing device of the seventh mode (7) for working the second preferred embodiment of the present invention

[FIG. 23] Bottom views showing the manner of installing the quake-absorbing device of the seventh mode (7) for working the second preferred embodiment of the present invention, wherein the processes of operation of the device are illustrated in (a) and (b) in order

[FIG. 24] Enlarged side view of the principal portion of the quake-absorbing device of FIG. 20(f) showing the seventh mode (8) for working the second preferred embodiment of the present invention.

[FIG. 25] Plan view showing the quake-absorbing device of the ninth mode (9) for working the second preferred embodiment of the present invention.

[FIG. 26] Side view of FIG. 25.

[FIG. 27] Enlarged perspective view of the principal portion (A) shown in FIG. 25.

[FIG. 28] Perspective view showing the quake-absorbing device of the tenth mode (10) for working the third preferred embodiment of the present invention.

[FIG. 29] Plan view, partly in section, showing the quake-absorbing device of FIG. 28.

[FIG. 30] Longitudinal sectional view taken along the center of the installed device of FIG. 29.

[FIG. 31] Plan view showing the quake-absorbing device of the eleventh mode (11) for working the third preferred embodiment of the present invention.

[FIG. 32] Longitudinal sectional view taken along the center of the installed device of FIG. 31.

[FIG. 33] Plan view showing the quake-absorbing device of the twelfth mode (12) for working the third preferred embodiment of the present invention.

### BEST MODE FOR CARRYING OUT THE INVENTION

The quake-absorbing device and installation method therefor according to the invention will be described on the basis of the preferred modes for carrying out the first second and third inventions.

FIG. 1 through FIG. 11 show the best mode for working the first embodiment of the invention.

The quake-absorbing device in regard to the present invention basically comprises an upper support platform, a lower support platform, upcurved rails, downcurved rails, and rollers. The rails and rollers are placed between the upper and lower support platforms. The upcurved and downcurved rails extend perpendicularly in the horizontal direction. The device for absorbing seismological vibrations according to the present invention is featured in that the upper support platform for bearing an object to be protected from an earthquake and the lower support platform secured on a floor are placed face to face between the protected object and the floor, and the second rails along which the first rollers move rotatively and the first rails along which the second rollers move rotatively are mounted between the upper support platform and the lower support platform, and that the upper and lower support platforms each have a wiring opening formed substantially in the middle portions thereof.

According to the structure noted above, since the first rails and first rollers are fixedly mounted separately from the movable second rails and second rollers between the upper support platform for bearing the protected object and lower support platform fixed on the floor, the setting space between the protected object and the floor can be reduced in elevation. The second rails and second rollers further serve as reinforcing means capable of increasing resistance to earthquake and preventing torsional deformation of the device. Accordingly, wiring cables or the like can run through the openings formed in the upper and lower support platforms without coming into contact with the rollers and rails. The wiring opening formed in the support platform may be formed in a circle, square, polygon or other shape so as to allow various wiring cables or lines to pass through the support platforms and be connected to electronic devices.

The quake-absorbing device of the invention is further featured by a protection member supported by one or both of the wiring openings formed in the upper and lower support platforms.

With the protection member, the wiring cables are guarded to ensure proper airflow.

The quake-absorbing device of the invention is further featured in which the protection member is formed of a support plate with a vent hole.

The protection member in the aforementioned quake-absorbing device serves to secure good ventilation around the wiring openings in the upper and lower support platforms.

The quake-absorbing device of the invention is further featured in which the wiring opening in the lower support platform is larger than that in the upper support platform.

With this structure, a passage for the wiring cables, which is defined by the wiring openings of the vertically overlapping support platforms, can be kept even if the upper and lower support platforms move irregularly when under vibration of an earthquake.

The quake-absorbing device of the invention is further featured in that the protection member may be made of elastic material.

With the elastic protection member, the wiring cables passing therethrough are elastically guarded even during earthquakes.

The quake-absorbing device of the invention is further featured in that the protection member may be made of non-elastic material.

The non-elastic protection member makes it possible to protect the wiring cables passing therethrough from dynamic interaction and shield electromagnetic waves generated from the wiring cables or the like.

The quake-absorbing device of the invention is further featured by comprising an air supply unit with ventilating fans.

With the ventilating fans mounted on the air supply unit, active ventilation in the space between the protected object and the floor can be fulfilled.

The quake-absorbing device of the invention is further featured in that the ventilating fans are mounted on the support plate.

With the ventilating fans mounted on the support plate, ventilating flow of air introduced through the openings in the upper and lower support platforms can be fulfilled. The ventilating fans can be mounted on the support plate without disrupting the function of the device for absorbing the vibrations or shocks of the earthquake. Besides, the ventilating fans integrally united with the support plate can be applied to the quake-absorbing device without restrictions of the structure and arrangement of the device.

The preferred embodiment of the quake-absorbing device according to the first invention will be described hereinafter with reference to the accompanying drawings.

FIG. 1 through FIG. 6 illustrate the first preferred mode (1) of the quake-absorbing device of the invention.

In this preferred mode (1), the floor F on which the protected object P is placed may be, for instance, a raised free-accessible floor for allowing wiring cables for communication lines, electric circuit system or the Like to pass therethrough, or a slab floor of a building framework. The illustrated device is installed on a mount base B fixed on the floor F. The wiring cables C are laid on the floor F and connected to the protected object P. The wiring cables C are generically named here as common communication line and electric circuit systems, but does not contemplate imposing any limitation on the diameter and shape thereof to be specified. The protected object P to which the wiring cable C is connected is computer equipment such as computer servers.

The quake-absorbing device of the first preferred mode (1) comprises, as principal parts, the upper support platform 1, lower support platform 2, first rails 3, second rails 4, first rollers 5, and second rollers 6.

The upper support platform 1 for supporting the protective object P is made of a relatively thick flat plate and shaped in a rectangle having a long side W2 and a short side W1. The upper support platform 1 has a wiring opening 7a formed in a square of W3 on a side substantially in the middle thereof. To either long side (extending in the longual direction) of the lower surface of the upper support platform 1, two first rollers 5, i.e. four rollers in total, are attached with bearing blocks 8. The protected object P is fixed onto the upper surface of the upper support platform 1.

The bearing blocks 8 each have a mount surface 8a attached to the upper support platform 1. The first roller 5 is mounted projecting the side of the bearing block 8, which is adjacent to the mount surface 8a.

The lower support platform 2 opposite to the floor F is made of a relatively thick flat plate formed in a rectangle substantially similar to the upper support platform 1. The lower support platform 2 has a wiring opening 7b formed in a square of W4 on a side substantially in the middle thereof. The opening 7b is made somewhat larger than the opening 7a. Onto either short side (extending in the crosswise direction) of the lower support platform 2, two first rails 3, i.e. four rails in total, having a length L are attached. The first rail 3 extends straight from side to side and is curved vertically. The first rails 3 placed on each side are arranged in parallel overlapping in part by the length D. The lower surface of the lower support platform 2 comes into contact with the mount base B.

Each second rail 4 along which the first roller 1 5 mounted on the upper support platform 1 runs is formed in a rail frame 9 shaped in a rectangular column. The second rail 4 extends straight in the direction in which two first rollers 5 move rotatively from side to side and is curved vertically.

The second roller 6 running along the first rail 3 mounted on the lower support platform 2 is mounted on a roller frame 10 shaped in a rectangular column. The second rollers 6 are mounted on either side of the roller frame 10 with different protruding lengths d1 and d2 by which the first rails 3 are displaced. The second rollers 6 are mounted on either side of the roller frame 10. The first rails 3 are arranged so as not to be distracted by the roller frame 10 when viewed from above. The rolling range S within which the second roller 6 moves rotatively along the first rail 3 when under horizontal vibrations of an earthquake is determined to be made around half the length L of the first rail.

The aforementioned rail frames 9 and roller frames 10 are arranged in a double cross so as to be formed like a carriage in conjunction with the second rails 4 and second rollers 6 and disposed movably between the upper support platform 1 and the lower support platform 2.

The device in the first mode (1) of the invention further comprises a protection member 12, which is fitted in the wiring opening 7a of the upper support platform 1 by using a support plate 11. The support plate 11 has a mount hole 11a at the center thereof for holding the protection member 12, a number of vent holes 11b arranged in a staggered state, and a mount brim 11c. The mount brim 11c is fixed to the upper support platform 1 with screws 13.

The protection member 12 is made of elastic material such as a conical cylinder of coil spring, which has a smallest diameter portion 12a in the vicinity of the lowermost part thereof and an expanded portion 12b larger in diameter than the smallest diameter portion 12 at the lowermost part. The protection member 12 is fitted into the mount hole 11a in the support plate 11 at the uppermost part thereof and has the expanded portion 12b placed in the wiring opening 7b of the lower support platform 2 in a free state and surrounded by the first rails 3, second rails 4, first rollers 5, and second rollers 6.

According to the aforementioned structure in the first mode (1), the first rollers 5 and second rollers 6 ascend and traverse the curved surfaces of the first rails 3 and second rails 4 (under the own weight of the protected object) when under horizontal vibrations, thus to cancel the vibrations. As a result, the horizontal energy of the seismological vitations can be absorbed with the up-and-down movements of the first rollers 5 and second rollers 6.

The rigid structure of the device, which is formed by the upper support platform 1 made of a relatively thick board for supporting the protected object P and provided with the first rollers 5 and bearing blocks 8 and the lower support platform 2 made of a relatively thick board fixed on the floor F and provided with the first rails 3, has quake-resistance and tolerance to deformation under torsion. Accordingly, the device of the invention can perform a quake absorbing function over a long period of time. The openings 7a and 7b formed in the upper and lower support platforms 1 and 2 can be made large to the fullest extent.

Two first rails 3 are arranged in parallel overlapping in part by the length D as shown in FIG. 2. Therefore, the respective rolling ranges of the second rollers 6 moving when under horizontal vibrations of an earthquake overlap by the overlapping length D, thus to transmit horizontal vibration energy damped by the amount of D to the upper support platform 1. As a result, the vibration damping effect of the device can be elevated.

Furthermore, the effective length of the first rails 3 can be reduced without shortening the rolling range within which the second rollers 6 move rotatively when under an earthquake, so that the entire size of the quake-absorbing device can be reduced.

The carriage-like structure formed of the second rails 4, second rollers 6, rail frames 9 and roller frames 10 is assembled movably within between the upper support platform 1 and the lower support platform 2 and are independent of the first rollers 5, bearing blocks 8 and first rails 3 fixedly mounted on the upper and lower support platforms 1 and 2. Therefore, the setting space defined between the upper support platform 1 and the lower support platform 2 can be made narrow, so that the quake-absorbing device can easily be installed on the floor F.

Furthermore, since the first rollers 5 and second rollers 6 are displaced vertically with respect to the second rails 4 and first rails 3 as viewed from side, the setting space defined between the upper support platform 1 and the lower support platform 2 can easily be narrowed. Similarly, since the first rollers 5 protrude from the respective sides adjacent to the mount surface 8a through the being blocks 8 secured to the upper support platform 1, the setting space defined between the upper support platform 1 and the lower support platform 2 can easily be narrowed and the first rollers can stably move rotatively along the second rails 4.

Hence, the wiring cables C connected to a display table, electronic devices and so on can be laid on the floor under the lower support platform 2 by making use of the space ensured by the mount base B between the floor F and the lower support platform 2. The wiring cables C pulled under the lower support platform are connected to the protected object P such as an electronic device through the wiring opening 7a in the lower support platform 2 and the protection member 12 (wiring opening 7a in the upper support platform 1). Thus, since needlessly long cables are not required, the seismic isolation effect brought about by the device incorporating the rails and rollers when under vibration of an earthquake is not impeded by the wiring cables C.

The protection member 12 having a function of absorbing the vibration energy as noted above comes in elastic contact with the wiring cables C at the smallest diameter portion 12a thereof when the upper and lower support platforms 1 and 2 are displaced laterally, while being distorted elastically, consequently to guard the wiring cables C. The protection member 12 can be elastically deformed through the expanded portion 12b. The expanded portion 12b of the protection member 12 is disposed free from the lower support platform 2, the protection member 12 can be deformed on a large scale.

The quake-absorbing device in the first preferred mode (1) of the invention has further advantage in that the inside of the protective member 12 and the mount hole 11a in the support plate 11 ensure a ventilating space for ensuring proper air flow A in the space between the protected object P and the floor F. With this structure, cooling air can be effectively circulated around the floor F (underfloor) and the protected object P such as an electronic device.

The first rollers 5 move rotatively a distance S1 in the direction of X in FIG. 6 along the second rails 4, and the second rollers 6 move rotatively a distance S2 in the direction of Y along the first rails when under vibration of an earthquake. At this time, a wiring passage formed by the openings 7a and 7b in the displaced upper and lower support platforms 1 and 2 is a rectangle defined by one side W5 and the other side W6, so that the wiring cables laid on the floor F and connected to the protected object P can securely pass therethrough without impeding movements of the first and second rails 3 and 4 and the first and second rollers 5 and 6 even under vibration of an earthquake. Accordingly, the quake-absorbing efficiency of the device can be maintained without damaging the wiring cables connected to the protected object P.

Since the opening 7b is made larger than the opening 7a, the wiring passage 7c defined by the sides W5 and W6 formed by the overlapping openings 7a and 7b can be ensured even if the upper support platform 1 moves under vibration, consequently to reliably pass the wiring cables C through the wiring passage. Meanwhile, if the opening 7a is made larger than the opening 7b, it is possible to reliably pass the wiring cables C through the wiring passage.

FIG. 7 illustrates the preferred mode (2) of the quake-absorbing device according to the present invention.

In this preferred mode (2), the protection member 12 as seen in the foregoing preferred mode (1) is shaped like a waistless cylinder having both ends held by the upper and lower support platforms 1 and 2. The protection member 12 in this embodiment is made of an inelastic sheet such as of aluminum or paper and has an electromagnetic shielding function to shield electromagnetic field emitted from the wiring cables C.

According to this preferred mode (2) of the invention, the wiring cables are completely isolated from the first rails 3, second rails 4, first rollers 5, and second rollers 6 so as not to be contaminated by coarse particles produced from the rails 3 and 4 and rollers 5 and 6.

The protection member made of aluminum or paper sheet can easily be shaped into a cylinder and offer functions of protecting the wiring cables C from dynamic interference and shielding electromagnetic field emitted from the wiring cables C.

The other operation and effect of the quake-absorbing device of the preferred mode (2) according to the invention are substantially the same as those of the foregoing mode (1).

FIG. 8 illustrates the preferred mode (3) of the quake-absorbing device according to the present invention.

In the quake-absorbing device of this preferred mode (3), the smallest diameter portion 12a found in the aforementioned preferred mode (1) is placed at the intermediate portion of the protection member 12 also found in the mode (1).

According to this quake-absorbing device in the mode (3), when the wiring cables C come into contact with the smallest diameter portion 12a in displacing the upper and lower support platforms 1 and 2 from each other, the wiring cables C can be securely protected with the elastic protection member 12.

The other operation and effect of the quake-absorbing device of the preferred mode (3) according to the invention are substantially the same as those of the foregoing mode (1).

FIG. 9 illustrates the preferred mode (4) of the quake-absorbing device according to the present invention.

In the quake-absorbing device of the preferred mode (4), the wiring cables C as found in the foregoing mode (1) are led out from the bottom of the rail frame 9 assembled like a carriage and disposed movably between the upper and lower support platforms 1 and 2.

According to this quake-absorbing device in the mode (4), the wiring cables C can be connected to the protected object P through between the upper and lower support platforms 1 and 2 and laid through a space formed between the rail frame 9 and roller frame 10 and the lower support platform 10. Therefore, the wiring cables C can be connected to the protected object P or laid on the floor F without passing through the openings 7a and 7b in the upper and lower support platforms 1 and 2, consequently to increase the flexibility of wiring arrangement with respect to the protected object P and the floor F.

Moreover, since the wiring cables C can be connected to the protected object P and laid on the floor F without passing through the openings 7a and 7b in the upper and lower support platforms 1 and 2, either of both of the upper and lower support platforms 1 and 2 may not need the wiring opening 7a and/or 7b. The other operation and effect of the quake-absorbing device of the preferred mode (4) according to the invention are substantially the same as those of the foregoing preferred mode (1).

FIG. 10 and FIG. 11 illustrate the preferred mode (5) of the quake-absorbing device according to the present invention.

In the quake-absorbing device in the mode (5), the support plate 11 as found in the aforementioned mode (1) is provided with an air supply unit H.

The air supply unit H comprises a ventilating fans 20 and not-shown small motors for driving the ventilating fans 20. Each small motor is mounted within the respective ventilating fans 20.

Each ventilating fan 20 comprises a square mount frame 21, moving vanes 22, and a rotating shaft 23.

The ventilating fans 20 having such components are mounted one on each of four corners of the support plate 11 securing the protection member 12. The ventilating fans 20 are disposed on the lower side of the support plate 11 within a space formed between the rail frame 9 and the roller frame 10.

According to the quake-absorbing device in the mode (5), heat generated from the protected object P such as an electronic device or computer server to be protected from an earthquake and wiring cables C can be effectively reduced with cooling air I, which is supplied to the protected object P along the surface of the floor F or from beneath the floor F (under floor). That is, the cooling air I is produced by the air supply unit H and forcibly fed to the protected object P so as to maintain the protected object P in good condition. Even if the protected object P incorporates an air conditioning unit such as a cooling device, air discharged from the air conditioning unit of the protected object P can be effectively sent out to the floor F.

With the air supply unit H, air or cooling air I passing through the protection member 12 may also be discharged forcibly, so that the air flow in the space between the protected object P and the floor F can be forcibly sent out or fed in.

Since the air supply unit H is secured on the support plate 11 fitted in the opening 7a, there is no need to form a setting space for accommodating the air supply unit beneath the upper support platform 1 or lower support platform 2. That is, the air supply unit may be designed arbitrarily in accordance with the arrangement of the wiring cables C. Alternatively, the air supply unit may be disposed on the edge portion of the opening 7b in the lower support platform 2 in place of the support plate 11. In either case, the air supply unit H can be mounted without obstructing movements of the upper and lower support platforms 1 and 2, rail frame 3, and roller frame 10. The other operation and effect of the quake-absorbing device of the preferred mode (5) according to the invention are substantially the same as. those of the foregoing preferred mode (1).

Further, it is possible to make the protection member 12 of rubber, though not illustrated in the drawings. In the case of making the protection member of rubber, it may be formed in a cylindrical shape or a bellows-like cylinder.

The wiring cables C passing through the protection member 12 may be of a metal cable or optical fiber.

The openings 7a and 7b formed in the upper and lower support platforms 1 and 2 are not limited to a rectangular shape and may have any other desired shape as a circle.

The ventilating fan 20 of the air supply unit H may possibly be provided with a small cooling device found in a personal computer for cooling a central processing unit (CPU).

Some embodiments of the quake-absorbing device according to present invention will be described in detail hereinafter.

(Embodiment 1)

In the quake-absorbing device shown in FIG. 2 and FIG. 6, the upper support platform 1 and the lower support platform 2 are formed in a rectangle having a longitudinal width W2 of about 900 mm and a transversal width W1 of about 700 mm, and the first rails 3 each having a length L of about 400 mm are attached to the lower support platform 2.

The maximum width W3 of the opening 7 may preferably be about 450 mm so as not to permit the wiring cables passing therethrough to reduce the quake-absorbing performance of the device due to interference between the wiring cables and the rail frame 9 and roller frame 10, which are assembled in the form of parallel crosses and disposed movably between the upper and lower support platforms 1 and 2.

The space formed between the upper and lower support platforms 1 and 2 may be about 80 mm in height. Consequently, in a case of placing a common server rack (protected object P) having a height of 2000 mm in general on the upper support platform 1 device of the invention, the system total height from the top of the rack to the floor F becomes 2100 mm.

In order to ensure the rolling ranges for allowing the second rollers 6 and first rollers 5 to move rotatively along the first rails 3 and second rails 4 and sufficiently fulfill the quake-absorbing function of the device, each length of the rails is required to be more than about 400 mm. That is, with respect to the outside dimension defined by W1 and W2 of the upper and lower support platforms 1 and 2, the transversal width W1 becomes more than about 800 mm at least where the two first rails are laid out in a line. But, in a case where the two first rails 3 are displaced in parallel, overlapping by the length D of about 100 mm, the longitudinal width W2 can be reduced while ensure the rolling range within which the second rollers 2 are enough movable along the first rails 3. In this case, the transversal width W1 can be made less than about 800 mm (W1=700 mm or so).

With respect to the rolling range D for allowing the first and second rollers 5 and 6 along the rails when under vibration, the rollers are movable within the range of 195 mm or so in a case where the aforementioned rail has a length L of about 400 mm Thus, the wiring passage, which is formed by the overlapping openings of the upper and lower support platforms 1 and 2 when under vibration, is defined by W5 of about 200 mm and W6 of about 200 mm at the maximum. Accordingly, the wiring cables passing through the wiring passage 7 formed by the overlapping openings can be protected sufficiently.

FIG. 12 through FIG. 27 illustrate another preferred embodiment for putting the second invention into practice.

The quake-absorbing device according to the present invention comprises the upper support platform, the lower support platform, curved rails disposed between the upper and lower support platforms, and rollers movable along the rails, which are arranged horizontally orthogonal to each other, wherein the quake-absorbing device is divided into a plurality of quake-absorbing units each having the rollers and rails arranged orthogonally so as to form a wiring passage opening vertically substantially in the middle between the adjacent quake-absorbing units, consequently to allow wiring cables laid within a space defined between a protected object and a floor to pass through the wiring passage surrounded by the quake-absorbing units.

According to the device noted above, the divided quake-absorbing units can be disposed around the wiring cables can be arranged between the floor and the protected object raised above the floor without interference from the wiring cables connected to the protected object. Since the divided quake-absorbing units are so arranged as to form the wiring passage substantially in the middle therebetween for allowing the wiring cables to let through the wiring passage, the quake-absorbing device of the invention can be retrofitted with the divided quake-absorbing units without interruption from the protected object to which the wiring cables have already been connected in an existing or newly installed quake-absorbing system.

Furthermore, since the quake-absorbing units constituting the quake-absorbing device of the invention have the rails and rollers arranged orthogonally in the horizontal direction, the wiring passage opening vertically can be formed substantially in the middle between the quake-absorbing units.

The quake-absorbing device of the invention is further featured in that the upper and lower support platforms are joined to each other by means of connection members attached to the opposite sides of the quake-absorbing units.

According to this structure, the upper and lower support platforms in the quake-absorbing units are mutually joined to each other via the connection members.

The quake-absorbing device of the invention is further featured in that the upper and lower support platforms in the quake-absorbing units are connected in position in the space between the floor and the protected object by the weight of the protected object.

According to this structure, the upper and lower support platforms in the quake-absorbing units can be stably joined to each other by the weight of the protected object without being secured on the floor and the protected object with anchor means such as bolts.

The quake-absorbing device of the invention is further featured in that the divided quake-absorbing units each have one set of rail and roller in the dividing direction and two sets of rails and rollers in the undividing direction.

According to this structure, since each quake-absorbing unit has two sets of rails and rollers in the undividing direction and one set of rail and roller in the dividing direction, the quake-absorbing device of the invention can be divided, and the quake-absorbing units can be fitly combined so as to form desirable wring passages in various manners.

The quake-absorbing device of the invention is further featured in that the passage for the wiring cables spreads vertically on the side of the floor.

According to this structure, the wiring cables can be prevented from being impeded from the wiring passage portions of the upper and lower support platforms.

The quake-absorbing device of the invention is further featured in that the rollers disposed on the divided quake-absorbing units are joined to each other by means of roller connection members attached to the sides of the quake-absorbing units.

According to this structure, the quake-absorbing units are maintained in their uniformity in the direction of vibrations of an earthquake, so as to carry out the quake-absorbing function without permitting the rollers to come off the rails laid in the dividing direction.

The quake-absorbing device according to the present invention comprises the upper support platforms, the lower support platforms, vertically curved rails disposed between the upper and lower support platforms, and rollers movable along the rails, which are arranged horizontally orthogonal to each other, wherein the quake-absorbing device is divided into a plurality of quake-absorbing units each having the rollers and rails arranged orthogonally so as to form a wiring passage opening vertically substantially in the middle between the adjacent quake-absorbing units arranged in the dividing direction, consequently to allow wiring cables laid within a space defined between a protected object and a floor to pass through the wiring passage surrounded by the quake-absorbing units, and wherein the divided quake-absorbing units are retrofitted to a plurality of existing protected objects set on the upper support platforms and connected to the wiring cables by lifting up the protected objects from the floor, assembling the quake-absorbing units within the space between the lifted protected objects and the floor, letting the wiring cables through the wiring passages, mutually connecting the upper support platforms and the lower support platforms on the sides of the quake-absorbing units in the dividing direction, placing the protected objects on the upper support platforms of the respective quack-absorbing units, and setting the respective lower support platforms on the floor.

According to the quake-absorbing device of the invention noted above, wiring cables can be laid within a space defined between a protected object and a floor to pass through the wiring passage surrounded by the quake-absorbing units, so that the quake-absorbing device constituted by the divided quake-absorbing units can be retrofitted upon lifting up the protected objects above the floor. Since the upper and lower support platforms can be mutually joined on the sides of the respective quack-absorbing units, the quake-absorbing device of the invention can be installed without interference from the wiring cables connected to the protected object.

Next, the quake-absorbing device according to the preferred embodiment for putting the second invention into practice will be described with reference to the accompanying drawings.

FIG. 12 through FIG. 21 illustrate the other preferred mode (6) of the quake-absorbing device of the invention and the method for installing the device.

Also in this preferred mode (6), the wiring cables C such as communication lines or electric circuit cables can be laid on the floor F on which the protected object P is placed. In this mode, the floor F may be, for instance, a raised free-accessible floor for allowing wiring cables for communication lines, electric circuit system or the like to pass therethrough, or a slab floor of a building framework. That is, the wiring cables C are laid on the floor F and connected to the protected object P. The wiring cables C are generically named here as common communication line and electric circuit systems, but does not contemplate imposing any limitation on the diameter and shape thereof to be specified. The protected object P to which the wiring cable C is connected is computer equipment such as computer servers.

The quake-absorbing device 100 in this embodiment comprises a plurality of quake-absorbing units 110 into which the quake-absorbing device is divided.

Each quake-absorbing unit 110 includes, as main components, the upper support platform 1, lower support platform 2, and first rails 3, second rails 4, first rollers 5, and second rollers 6, which are arranged orthogonal in the horizontal direction. The quake-absorbing device in this embodiment is composed of two quake-absorbing units 111 and 112.

As shown in FIG. 13, the quake-absorbing units 110 are joined to each other with a connection member 121 for mutually connecting the upper support platforms and a connection member 122 for mutually connecting the lower support platforms.

Each upper support platform 1 is formed of a box-like member made of relatively thick flat boards and having dimensions of long side W11, short side W12 and height (thickness) W12a. Along the short sides W12 of the lower surface of the upper support platform 1, there are mounted first rails 3 on which the first rollers 5 move rotatively. This invention does not contemplate imposing any limitation on the shape of the upper support platform 1, inasmuch as it is made flat so as to mount the first rails thereon.

The first rail 3 is much the same in length as W12 so as to substantially coincide with the short side W12 of the upper support platform 1. The first rail is vertically curved and extends straight in the horizontal direction in which the rollers 5a and 5b mounted on either side of the platform move rotatively. The vertically curved parallel rails 3a and 3b each have length W19 are attached to the upper support frame 1 for guiding the first rollers 5.

The first roller means 5 is constructed by mounting rollers 5a and 5b movable for the distance W19 similar to that of the rails 3a and 3b on a carriage 9, which will be described in detail later. Since two rails 3a and 3b constituting the first rail means 3 are arranged in parallel, the rollers protrude from the carriage 9 by the same length.

Each lower support platform 2 is formed of a box-like member made of relatively thick flat boards and having dimensions of long side W11, short side W12 and height (thickness) W14a Along the long sides W11 of the upper surface of the lower support platform 2, there are mounted second rails 4. Similarly to the upper support platform, the shape of the lower support platform 2 should not be limited thereto. The relation in size between the short side W12 of the upper support platform 1 and the short side W14 of the lower support platform 2 is expressed by W12>W14.

The second rail means 4 includes one pair of rails 4a and 4b each placed on either side of the platform, which are vertically curved and extend horizontally. That is, four rails in total are mounted. Each rail has a length L1 along which the second roller moves rotatively. The two second rails are separated at the distance W21 and arranged orthogonally to the fist rails 3.

The second roller means 6 is mounted on a column-formed carriage 90 touched upon later similarly to the aforementioned first roller 5. The second roller means is provided on either side with the rollers 6a and 6b counterpart to the paired rails 4a and 4b. The rollers 6a and 6b protrude from the carriage 90 by the same length.

The carriage 90 is formed like a column and provided on its long sides with second rollers movable rotatively along the second rail means 4 and on its short sides with first rollers 5 movable rotatively along the first rail means 3 between the upper and lower support platforms 1 and 2.

The first rollers 5a and 5b are normally located substantially at the middles of the respective first rails 3a and 3b so as to move for the distance W19. The second rollers 6a and 6b are rotatively movable for the distance W18 similarly to the first roller 5. Thus, the first and second rollers 5 and 6 move rotatively within the respectively determined ranges of the rails when under vibration of an earthquake. The distance for which each roller moves rotatively is about half of the length of the rail along which the relevant roller moves.

Hence, each of the quake-absorbing units 111 and 112 is provided with one pair of first rail 3 and first roller 5 in a dividing direction in which the first rail 3 extends and with two pairs of second rails 4 and second rollers 6 in another dividing direction in which the second rail 4 is laid orthogonal to the first rail 3.

As shown in FIG. 16, each connection member 121 is formed like a rectangle having long side W112, short side W113 and length equal to substantially W15 so as to come into contact with a contact piece 1d and a side member 1c, which are mounted on the connection member 130 of each upper support platform 1. The side member 1c has positioning pins 1e secured thereon and connection holes 1f into which connection screws 123 are fitted. The connection member 121 has positioning holes 121a for receiving the positioning pins 1e and insert holes 121b into which the connection screws 123 are fitted.

Similarly to the connection member 121, each connection member 122 is formed like a rectangle having long side W114, short side W115 and length W15 so as to come into contact with a contact piece 2d and a side member 2c, which are mounted on the connection member 130 of each lower support platform 2. The side member 2c has positioning pins 2e secured thereon and connection holes 1f into which connection screws 124 are fitted. The connection member 122 also has positioning holes 122a for receiving the positioning pins 2e and insert holes 122b into which the connection screws 124 are fitted.

The connection screws 123 and 124 have hexagonal sockets 123a and 124a into which a hexagonal wrench is fitted Each of the holes 121b and 122b correspond to the connection screws 123 and 124, respectively, and holes 121c and 122c are formed corresponding to the heads of the connection screws 123 and 124.

Connection of the quake-absorbing units 111 and 112 with the connection members 121 and 122 configurates the quake-absorbing device 100. The distance between the upper support platforms 1 in the quake-absorbing units 111 and 112 is W16, and the distance between the lower support platforms 2 is W17. Assuming that the areas of the openings 7a and 7b surrounded by the quake-absorbing units 111 and 112 and the connection members 121 and 122 are K1 and K2 respectively, the equation K1<K2 are formulated.

Next, the method for installing the quake-absorbing device 100 of the invention will be described with reference to FIG. 20.

First, the protected object P is connected to the wiring cables C laid on the floor F as shown in FIG. 20(a). The existing protected object P in FIG. 20(a) is lifted up with a lifting machine such as a pawljack 150 having pawls 151. Although one or more pawljacks 150 are used in this embodiment, this should not be understood as being limited thereto, and any other tool may be used for raising the protected object P to the height of Y from the floor F. Of course, the protected object P may be hoisted to the height of Y from the floor. Thus, this should not be understood as being limited to the specific means for lifting the protected object and may have any other desired types of lifting devices.

The space having the height Y for receiving the quake-absorbing units 111 and 112, which is assured by raising the protected object P to the height Y by using the jack 150, should be more than the height W of the respective quake-absorbing units 111 and 112. Upon assuring the space of height Y, a temporary support means 160 is inserted into the space of height Y to assure the space of height Y around the wiring cables C and securely support the protected object P, and then, the jack 150 is removed (FIG. 20(b))

Then, the quake-absorbing units 111 and 112 are inserted into the space of height Y assured by the temporary support means 160. The quake-absorbing unit 111 is so set as to place the end portion P1 of the protected object P substantially in the middle of the upper support platform 1 (FIG. 20-(c)). Thereafter, the quake-absorbing unit 112 is similarly set so as to place the end portion P2 of the protected object P substantially in the middle of the upper support platform 1 (FIG. 20-(d)). The quake-absorbing units 111 and 112 thus arranged can easily be applied to the protected object P while assuring the passage Z for the wiring cables C without touching the wiring cables C. Consequently, the wiring cables C can be suitably held in position in the passage Z defined between the quake-absorbing units 111 and 112.

Upon installing the quake-absorbing units 111 and 112, the temporary support means 160 is removed. The temporary support means 160 is removed by using the pawl jacks 150, which was before used to raise the protected object P, by inserting the pawls 151 of the pawl jacks 150 into, for instance, spaces formed beneath the protected object P adjacent to the quake-absorbing units 111 and 112, which spaces are defined outside the quake-absorbing units 111 and 112. In the state of setting the pawl jacks 150 at the desired positions for firmly holding the protected object P, the temporary support means 160 is removed (FIG. 20(e)).

After removing the temporary support means 160, the quake-absorbing units 111 and 112 are subject to ultimate positioning adjustment for being set onto their exact positions. For setting the quake-absorbing units 111 and 112 onto the exact positions, the protected object P is lowered slowly by using the pawl jack 150 so as to be placed on the upper support platforms 1 of the respective quake-absorbing units 111 and 112 (FIG. 20(f)).

Confining that the protected object P is set on the quake-absorbing units 111 and 112 in its stable state, the upper and lower support platforms 1 and 2 of the quake-absorbing units 111 and 112 are joined with the connection members 121 and 123. Thus, installation of the quake-absorbing device 1 is completed. (FIG. 20(g))

The operation of the quake-absorbing device 100 under vision of an earthquake will be described hereinafter.

As shown in FIG. 17, the first rollers 5a and 5b are located substantially in the middles of the first rails 3a and 3b of the first rail means 3, which extend straight horizontally and are curved vertically. At this time, if the floor F sets up horizontal vibrations, for example, in the direction D in FIG. 19, due to an earthquake, the upper support platforms 1, which carry the protected object P thereon and are joined to each other with the connection members 121, move in the direction E.

As the floor F moves in the direction D, the first rails 3a and 3b attached to the upper support platforms 1 move to allow the first rollers 5a and 5b to rotate therealong until positioning the rollers 5a and 5b at the rail ends 30c. The first rollers 5a and 5b move within their moving distance (about ½ of the length of each rail) from the middles 30a to the rail ends 30c. Thus, the protected object P also moves the length of (½)×W12 at the maximum in the direction E in conjunction with the first rails 3 moving in the direction E.

For instance, when the first rails 3 move on the first rollers 5a within the maximum stroke in the direction E, the first rails 3 move to the rail ends 30c on the first rollers 5a Thereafter, the first rails 3a and 3b move in the direction D until the first rollers 5a and 5b move close to the other tail ends 30b. Therefore, the curved first rails 3 move vertically on the first rollers 5 with the horizontal vibrations, consequently to vanish the vibrations, and then, the first rails 3 fall down by their own weight (including the load of the protected object P). Thus, the horizontal vibrations are absorbed and damped by the vertical movements of the first rails 3.

The relation of the second rails 4 and second rollers 6 is contrary to that of the first rails 3 and first rollers 5. That is, with the vertical movements of the second rollers, the horizontal vibrations are absorbed and damped.

In the preferred mode (6), the quake-absorbing units 111 and 112 are arranged so as to form the wiring passage Z for allowing the wring cables C to pass vertically therethrough substantially at the middle of the protected object P, and installed around the wiring cables C laid in the space defined by the protected object P and the floor F Hence, since the wiring cables C pass through the passage Z, the quake-absorbing device of the invention can be retrofitted to the existing protected object P. That is, the quake-absorbing device 100 according to the present invention can be applied to the existing protected object P without suspending the operation of the protected object P nor cutting the wiring cables C in service. Furthermore, since the quake-absorbing units 111 and 112 are joined to each other with the connection members 121 and 122 after installing the quake-absorbing units 111 and 112 in position, the quake-absorbing units 111 and 112 never interfere with the wiring cables C.

The quake-absorbing units 111 and 112 into which the quake-absorbing device is divided are each provided with one pair of first rail 3 and first roller 5 and two pairs of the second rails 4 and second rollers 6 arranged orthogonal to the first rail 3, consequently to realize unitization of the quake-absorbing device. As a result, the quake-absorbing device thus unitized can be applied to not only newly installed object to be protected, but also an existing protected object P Thus, the quake-absorbing device having a wide adaptive flexibility can be provided according to the present invention.

Each of the setting distances W16 (W17) for the quake-absorbing units 111 and 112 is independently disposed, so that the quake-absorbing device of the invention can be applied for various types of protected objects P by preparing a variety of connection members 120 having different lengths in accordance with the shape, size and setting of the protected object C. Besides, installation of the quake-absorbing device 100 of the invention is independent of the aspect of the protected object P.

For example, in a case that a plurality of existing protected objects P are arranged in parallel as shown in FIG. 21, one quake-absorbing unit 110 is disposed for two of the protected objects P. Unlike in the conventional case of using one quake-absorbing device for one protected object P. three quake-absorbing units 110 constituting a single quake-absorbing device according to the present invention suffice for two protected objects P Thus, the quake-absorbing device 100 of the present invention can be reduced remarkably in number for being applied to many protected objects, and therefore, contribute to cost reduction in service. Furthermore, by varying the length of the connection member 120, it is possible to freely adjust the distance (space of the passage Z) between the quake-absorbing units 110 and join a plurality of quake-absorbing units 110 to one another with a single connection member 120.

The quake-absorbing device 100 is composed of the unitized quake-absorbing units 111 and 112 and connection members 121 and 122, so that the quake-absorbing units 110 can be lightened to be easy to carry and install, consequently to reduce the transport and installation costs.

Since the opening 7b in the lower support platform 2 is made larger than the opening 7a in the upper support platform 1, the space defining the passage Z on the floor F becomes larger than the passage Z for the protected object P. Thus, the openings in both the upper and lower support platforms 1 and 2 widely overlap each other when under vibrations of an earthquake, resulantly to prevent the protected object P from interfering with the wiring cables C.

The quake-absorbing units 111 and 112 are mutually joined to the respective upper and lower support platforms 1 and 2, so that the quake-absorbing device can be retrofitted to the protected object C with ease. Besides, the upper and lower support platforms are provided on their sides with the connection members 120, consequently to facilitate fixing of the connection members 120 and stably offer the quake-absorbing performance without degrading the quake-absorbing efficiency.

The quake-absorbing unit 110 need not be fixed on neither protected object P nor floor F. The protected object P placed around the wiring cables C is raised from the floor to form the space for letting the wiring cable C therethrough so as to be independent of the floor F. Thus, installation of the quake-absorbing device 100 of the invention is unconstrained.

Moreover, since the upper support platform 1 carrying the protected object P is practically reinforced by the first rails 3, the quake-absorbing device is prevented from being subject to deformation under torsion when operated to absorb and damp vibrations of an earthquake, and therefore, good for a long-running effective quake-absorbing effect.

FIG. 22 and FIG. 23 illustrate the preferred mode (7) of the quake-absorbing device of the invention.

In this mode (7), before the quake-absorbing units 110 are fitted into the space Y defined vertically, the plurality of quake-absorbing units 110 used in the aforementioned mode (6) are arranged in advance at the distance for accommodating the wiring cables C. The quake-absorbing units 110 between which the wiring passage Z is formed are joined to each other on their one sides 131 with the connection members 120 into the form of a substantially U shape. Then, the plurality of quake-absorbing units 110 are inserted into the vertically defined space Y from the other sides 132, which are not joined with the connection members 120. The quake-absorbing units 110 and connection members 120 in this mode are the same as those in the aforementioned mode (6).

The quake-absorbing device 100 in the mode (2) has a definite relation between the quake-absorbing units 110 and the wiring cables C, so that they can be adjusted in position so as not to interfere with the wiring cables C. Consequently, the quake-absorbing units 110 can easily be laid out all together without being disturbed by the wiring cables C only by assuring the wiring passages Z in advance between the protected objects P connected to the wiring cables C. The other operation and effect of the quake-absorbing device of this preferred mode according to the invention are substantially the same as those of the foregoing mode (6).

Next, a manner for installing the quake-absorbing device 100 in the preferred mode (7) will be described with reference to FIG. 23.

Similarly to the aforementioned mode (6), the vertically defined space Y between the protected object P and the floor F is assured by using of a jack 150. Into the vertically defined space Y, the plurality of quake-absorbing units 110 joined with the connection members 120 at their one sides 131 are inserted from the other sides 132 which are not joined (FIG. 23(a)). At this time, the wiring cables C are introduced to the non-joined sides 132 in the mounting distance R, so that the quake-absorbing units are set in position without interference from the wiring cables C. Since the quake-absorbing units are joined to each other at their one sides with the connection members 120, the quake-absorbing units can be assembled only by joining the other sides 132 with the connection members 120 without being adjusted in position to complete formation of the desired quake-absorbing device 100 (FIG. 23(b)).

FIG. 24 illustrates the preferred mode (8) of the quake-absorbing device of the invention.

In this mode (8), the quake-absorbing units 110 are not joined with the connection members 120 after being inserted into the vertically defined space Y The quake-absorbing units 111 and 112 are steadied in position within between the protected object P and the floor F by making use of the weight of the protected object P. The quake-absorbing units 110 and connection members 120 are the same as those in the aforementioned mode (6).

The lower support platform 2 carrying the quake-absorbing units 111 and 112 encounter a reaction force G1 suffered from the weight G of the protected object P. Thus, the protected object P comes in close contact with the upper support platform 1 by the reaction force G1 brought about by the weight G of the protected object P, consequently to bring the lower support platform 2 into close contact with the floor F.

Hence, the quake-absorbing units 111 and 112 can be steadily secured in position cooperatively with the upper and lower support platform 2 as one unit by the weight G of the protected object P even if the quake-absorbing units 111 and 112 are not joined by use of the connection members 121 and 122, resupply to effectively absorb and damp the vibrations of an earthquake. Thus, the positioning of the plurality of quake-absorbing units 110 can easily be carried out irrespective of the conditions of the protected object P and the floor F, so that the quake-absorbing units 110 can be properly arranged in position and joined. The other operation and effect of the quake-absorbing device of this preferred mode according to the invention are substantially the same as those of the foregoing preferred mode (6).

FIG. 25 through FIG. 27 illustrate further preferred mode (9) of the quake-absorbing device of the invention. In the quake-absorbing device of this mode (9), the first rollers 5a mounted on the quake-absorbing unit 111 as found in the aforementioned modes (6)-(8) and the first roller 5a mounted on the quake-absorbing units 112 are joined with the connection member 200, and the counterpart first rollers 5b are also joined with the connection member 200.

The roller connection member 200 for connecting the rollers is made of a long flat plate or long beam having a L-shaped cross section and has a connection part 200a connected to the first rollers 5, and an extension part 5b formed perpendicular to the connection part 200a. In the connection part 200a, there are formed connection holes 201 for the first rollers 5.

Between the roller connection member 200 and the first roller 5, there is an extension member 205 having the length d9 protruding from the first roller 5 to enable connection between the connection member and first roller without inhibiting the quake-absorbing function of the first rollers 5a and 5b. The extension member 205 has a screw rod 125 for being fitted into the connection hole 201. The extension member 205 may be formed integrally with the first roller 5 in one body.

Hence, as shown in FIG. 27, the screw rod 125 of the extension member 205 extending from the first roller 5 is inserted into the connection hole 201 in the roller connection member 200 and then fastened with a screw nut 126, so that the first roller 5a of the quake-absorbing unit 111 and the first roller 5a of the quake-absorbing unit 112 are firmly joined to each other through the connection of the first roller 5 to the roller connection member. The first roller 5b of the quake-absorbing unit 111 and the first roller 5b of the quake-absorbing unit 112 are also joined to each other in the same manner.

The direction of absorbing the vibrations of an earthquake and the moving distance (rolling range) in which the rollers are movable in the quake-absorbing units 111 and 112 of this mode (9) become equal, so that the upper and lower support platforms 1 and 2 can be prevented from being displaced due to the individual quake-absorbing operations of the quake-absorbing units 111 and 112 (i.e. horizontal rotating displacement between the upper and lower support platforms 1 and 2). Thus, the quake-absorbing units 111 and 112 stably work well for absorbing vibrations of an earthquake without deflecting the first rollers 5 from the third rails arranged in the dividing direction.

The roller connection member 200 can easily be removed after installing the quake-absorbing units 111 and 112 onto the protected object P from the sides of the quake-absorbing units 111 and 112 in the same manner as that for mounting the connection member 120 in the aforementioned mode (6), consequently increasing the working efficiency.

In addition, the plurality of quake-absorbing units 110 can be joined with one roller connection member 200 in the same manner as that of arranging a plurality of protected objects P with the connection member 120, as shown in FIG. 21. Besides, the roller connection member 200 can easily be retrofitted to the quake-absorbing units 111 and 112 after installation of the units onto the protected object P, consequently to further increase the working efficiency. The other operation and effect of the quake-absorbing device of this preferred mode according to the invention are substantially the same as those of the foregoing preferred modes (6)-(8).

In addition to the embodiments illustrated in the drawings, it is possible to easily adjust the length of the connection member 120 with a proper adjusting mechanism so as to freely change the distance between the quake-absorbing units 110.

Also, it is possible to let air through around the floor F and the protected object P by force by assembling an air supply unit with ventilating fans into the connection member 120, thus to work the protected object P effectively.

The joint of the quake-absorbing units with the connection member 120 can be fulfilled only by connecting the upper support platforms 1 to each other and the lower support platforms 2 to each other. The manner of connecting the platforms should not be understood as being limited thereto.

Next, the present invention will be described in detail referring to the preferred embodiments.

(Embodiment 2)

Each of the upper and lower support platforms 1 and 2 of the quake-absorbing units 111 and 112 is formed in a rectangular shape having W12 of about 400 mm in the upper support platform, W14 of about 200 mm in the lower support platform, and longitudinal width W11 of about 890 mm. The first rail 3 having a length of about 400 mm is attached to the upper support platform 1.

The quake-absorbing units 111 and 112 thus formed are installed in the same manner as that shown in FIG. 20. The protected object P in this embodiment is formed in a cube 700 mm on a side. To the lower portion of the protected object P, the wiring cables C laid on the floor F are connected.

The quake-absorbing units 111 and 112 are disposed so as to place the middle of the upper support platform 1 at the end portion of the protected object P, and then, the upper and lower support platforms 1 and 2 of the respective quake-absorbing units are mutually joined to each other with the connection members 121 and 122 each having a length of 1100 mm. By using the quake-absorbing device thus formed, it was confirmed that the quake-absorbing device of the invention could be easily installed without disconnecting the wiring cables C from the protected object P. In addition, the quake-absorbing units each having a remarkably low height W of about 100 mm could conveniently be applied to an existing protected object P.

FIG. 28 through FIG. 33 illustrate the preferred embodiment according to the third invention.

This embodiment of the invention is related to the quake-absorbing device comprising vertically curved rails extending strait horizontally, rollers movable rotatively on the rails, which are orthogonally arranged substantially at right angles so as to be formed in parallel crosses, the upper support platform for carrying the protected object, and the lower support platform secured on the floor, which platforms are located between the protected object and the floor, wherein the second rails for the first rollers and the second rollers movable rotatively along the first rails are disposed between the upper and lower support platforms, and the first rails for the second rollers are arranged in parallel overlapping in part with each other.

According to the structure noted above, since the paired first rails overlap with each other in parallel, the length in which the rollers are movable rotatively can be assured to give a sufficient quake-absorbing performance. Thus, the effective longitudinal length of the first rails can be shortened by the overlapping amount, to reduce the size of the quake-absorbing device. Besides, the rails and rollers can be separated fixedly or movably to make the space for installing the device narrow in height. The upper and lower support platforms are disposed in between the protected object and the floor and practically reinforced by the first rollers, thus increasing the earthquake protection performance and the resistance to deformation under torsion.

Moreover, the quake-absorbing device according to the invention is further featured by a pair of second rollers protruding with different lengths from the roller frame in the direction perpendicular to the lengthwise direction of the first rail, and the second rollers movable rotatively along the first rails overlapping in part with each other.

According to this structure, since the paired second rollers move rotatively along the partly overlapping first rails, the vibrations of an earthquake, which are transmitted to the protected object, can be damped effectively.

In addition, since each second roller is disposed in between the first rail and the roller frame, the space for installing the device can be reduced in height.

Further, the quake-absorbing device of the invention is featured in that the pair of second rails are arranged overlapping in part with each other.

According to this structure, the moving distance in which the first rollers move rotatively along the second rails can be assured by arranging the paired second rails overlapping in part with each other, thus to give a sufficient quake-absorbing performance.

Further, the quake-absorbing device of the invention is featured in that a pair of first rollers protruding with different lengths from bearing blocks are disposed perpendicular to the longitudinal direction of the second rails, and the second rails for the first rollers are arranged in parallel overlapping in part with each other.

According to the aforementioned structure, when the first rollers disposed in pair move rotatively on the overlapping parts of the paired second rails, the vibrations of an earthquake, which are transmitted to the protected object, can be damped effectively owing to the overlapping parts of the second rails.

In addition, the first rollers are not placed between the second rails and bearing blocks, but protrude from the bearing blocks, the space for installing the device can be reduced in height.

Further, the quake-absorbing device of the invention is feature in that the paired second rails are formed integrally in one body in a column shape.

According to the structure noted above, resistance to earthquake of the quake-absorbing device of the invention can be improved while preventing torsional deformation of the device.

Net, the quake-absorbing device in the preferred embodiment for working the third invention will be described with reference to the accompanying drawings.

This preferred embodiment for putting the third invention into practice is specifically related to the overlapping structure of the first and second rails in the foregoing preferred embodiments for working the first and second inventions.

FIG. 28 through FIG. 30 illustrate the preferred mode (10) of the quake-absorbing device according to the invention.

The quake-absorbing device of this mode (10) has a significance of the floor F as found in the first invention described above and the paired rail overlapping in part as also found in the first invention described above.

As the quake-absorbing device 100 in the preferred mode (10) has substantially the same structure as in the aforementioned first invention, there will be described different components, which are not found in the foregoing embodiments. Although the quake-absorbing device 100 in this embodiment featured by the paired rails overlapping in part has no opening passage for the wiring cables C between the upper and lower support platforms 1 and 2 for purposes of illustration, the principal components found in the foregoing embodiments may of course be applied to this embodiment for working the third invention.

The first rollers 5 in the quake-absorbing device 100 according to the preferred mode (10) are each formed of the pair of rollers 5a and 5b disposed on either side, i.e. four rollers in total, which are separated by the distance R2 and protrude from the adjoining stationary side surfaces 8a of the bearing portions 8.

The first rails 3 are each formed of the pair of vertically curved rails 3a and 3b extending straight horizontally in parallel on either side, which overlap in part with each other by the length D1. The paired rails disposed on either side, i.e. four rails in total each have the length L1 along which the second roller 6 moves rotatively.

The second rollers 6 are each formed of the paired rollers 6a and 6b corresponding to the paired rails 3a and 3b disposed in parallel on either side and overlapping in part by the length D1. The paired rollers 6a and 6b disposed on either side respectively protrude from the roller frame 10 with the different protruding lengths d1 and d2.

The second rails 4 along which the paired rollers 5a and 5b disposed on either side are movable rotatively are each formed of vertically curved rails 4a and 4b extending straight horizontally. Since the paired rails 4a and 4b are disposed in parallel on the same reference axis, they protrude from the bearing blocks 8 for the first rollers with the same protruding length The paired rail frames 9 and the paired roller frame 10, which are arranged in parallel crosses, are formed like a carriage in conjunction with the second rails 4 and second rollers 6 and movably disposed in between the upper and lower support platforms 1 and 2.

The first rollers 5a and 5b are respectively located at the distance of R2 substantially at the middles of the second rails 4a and 4b. The second rollers 6a and 6b are arranged at the distance R1 in the same manner as the first rollers 5. Therefore, the first rollers 5 and the second rollers 6 move rotatively along the corresponding rails within the moving distances defined by the lengths of the rails when under vibrations of an earthquake. The respective moving distances are equal substantially to ½ of the lengths of the rails as denoted by strokes S2 and S1.

The first rails 3 of the quake-absorbimg device 100 thus constructed are arranged by overlapping in part by the distance D1, but not lined up in a row. Therefore, the quake-absorbing device in this embodiment is formed like a rectangle having a short side defined by W1=L1+L1−D1. That is, the quake-absorbing device can be reduced in length by the overlapping length D1.

Furthermore, since the quake-absorbing device 100 shortened by the length D1 is reduced in length without shortening the first rails, the lengths L of the respective rails can be assured, so that the rollers can move rotatively along the rails having sufficient lengths, consequently to call forth a sufficient quake-absorbing performance when under vibrations of an earthquake.

Accordingly, the present invention can provide the quake-absorbing device 100 capable of being applied to any protected objects P independent of the configuration and size of the protected object without being restricted by the lengths of the first rails 3.

Since the rail frame 9 and roller frame 10 are assembled in the form of parallel crosses and fitted into between the upper and lower support platforms 1 and 2, the first rollers 5a and 5b can easily be disposed protruding from the sides of the bearing blocks 8 adjacent to the stationary surface 8a perpendicularly in the longitudinal direction of the second rails, so that the height defined between the upper and lower support platforms 1 and 2 can be made shorter by the thicknesses of the first rollers 5a and 5b than those disposed on the side opposite to the stationary surface 8a. As a result, the center of gravity of the protected object P can be lowered, consequently to stabilize the protected object P on the upper surface of the upper support platform 1.

Furthermore, since the second rollers 6a and 6b protruding from the roller frame 10 are disposed protruding vertically in the longitudinal direction of the first rail as well, the space defined between the upper and lower support platforms 1 and 2 is reduced in height, consequently to lower the center of gravity of the protected object P.

In addition, the second rollers 6a and 6b corresponding to the first rails 3a and 3b overlapping with each other by the length D1 protrude from the roller frame 10 with different protruding lengths d1 and d2. Thus, the weight of the protected object P is supported on two lines, but not one line as in the conventional quake-absorbing device, so that the protected object P can be supported on the broad range of the quake-absorbing device 100 in a considerably stable state.

As shown in FIG. 30, the quake-absorbing function of this embodiment is practically the same as that of the foregoing preferred embodiments for working the first invention, but the quake-absorbing device of this invention is specifically characterized by the paired first rails 3a and 3b disposed in parallel overlapping by the length D1.

In this embodiment, the second rollers 6a and 6b are movable rotatively in the horizontal direction within the moving range S1 including the overlapping length D1. In movement of the second rollers in the overlapping length D1, the horizontal vibrations being transmitted to the upper support platform 1 are damped by vibrational energy corresponding to the overlapping length D1. Consequently, quake-absorbing efficiency can be enhanced remarkably.

FIG. 31 and FIG. 32 illustrate the preferred mode (11) of the quake-absorbing device according to the present invention.

In this preferred mode (11), the paired second rails as found in the aforementioned preferred mode (10) are disposed overlapping in part to form the overlapping length D2 similarly to the first rails.

The paired second rails 4 in the preferred mode (2) each have a length of L2 and extend straight horizontally so as to allow the rollers 5a and 5b on either side to move rotatively therealong. The second rails are each formed of the rails 4a and 4b curved vertically and arranged in parallel overlapping in part with each other by the overlapping length D2. The rails 4a and 4b are united integrally to the column-shaped roller frame in one body.

The first rollers 5 are each formed of rollers protruding from the bearing block 8 with different lengths on either side corresponding to the paired rails 4a and 4b having the overlapping length D2. The rollers 5a and 5b protrude by the lengths d3 and d4 from the sides adjacent to the stationary sure 8a of the bearing blocks 8.

The quake-absorbing device in this preferred mode (11) is formed like a rectangle having a side defined by W2=L2+L2−D2. That is, the quake-absorbing device can be reduced in length by the overlapping length D2.

Accordingly, the present invention can provide the quake-absorbing device 100 capable of being applied to any protected objects P independent of the configuration and size of the protected object without being restricted by the lengths of the respective rails.

In addition, since the first rollers 5a and 5b constituting the rollers 5 protrude by the protruding lengths d3 and d4 correspondingly to the second rails 4 overlapping with each other, the weight of the protected object P is effectively dispersed, consequently to bring about the stable quake-absorbing effect.

Moreover, the paired second rails 4a and 4b are united integrally to a column-shaped rail frame 9 in one body, thus increasing the earthquake protection performance and the resistance to deformation under torsion, and besides, they can easily be produced at low cost by using NC machine tools or the like.

As shown in FIG. 32, the paired first rails 4a and 4b are disposed overlapping with each other by the overlapping length D2, so as to allow the first rollers 5a and 5b to overlap with each other in the overlapping length D2 when moving rotatively along the rails in the moving range S1. As a result, the horizontal vibrations of an earthquake can be damped by the vibrational energy with respect to the movement of the rollers moving in the overlapping length D2, and then, the damped horizontal vibrations are transmitted to the upper support platform 1. Thus, the performance of absorbing and damping the vibrational energy can be improved. The other operation and effect of the quake-absorbing device of this preferred mode according to the invention are substantially the same as those of the foregoing preferred mode (10).

FIG. 33 illustrates the preferred mode (12) of the quake-absorbing device according to the present invention.

The quake-absorbing device in the preferred mode (12) has the paired second rails 4 overlapping in part with each other by the overlapping length D1 on either side of the device 100 in the aforementioned embodiment for working the second invention.

The paired second rails 6 protrude from either side of the carriage 9 with different protruding lengths corresponding to the paired rails 4a and 4b disposed overlapping in part by the overlapping length D1. The rollers 6a and 6b protrude from the carriage 9 by the protruding lengths d1 and d2, respectively.

The quake-absorbing device 100 in this mode (12) is formed like a rectangle having a long side defined by W11=L1+L1−D1. Consequently the quake-absorbing device 100 can be reduced in size without impairing the quake-absorbing performance.

Further, similarly to the preferred mode (11) noted above, the second rollers 6a and 6b are movable rotatively in the horizontal direction within the moving range T2 (equivalent to about ½ of the length of the rail) from the middles to one end portions of the respective rails.

At this time, since the moving range T2 within which each of the second rollers 6a and 6b moves rotatively with the horizontal vibrations of an earthquake overlaps with the overlapping length D1, the vibrations are damped by the amount corresponding to the overlapping length D1, consequently to improve the quake-absorbing performance. The other operation and effect of the quake-absorbing device of this preferred mode according to the invention are substantially the same as those of the foregoing preferred mode (11).

The preferred modes for working the first to third inventions do not contemplate imposing any limitation on the configuration of the quake-absorbing device. The quake-absorbing device according to the invention may of course be modified and combined in various manners.

Industrial Applicability

As is apparent from the foregoing description, the quake-absorbing device in the preferred modes for working the first invention has the rails and rollers disposed fixedly or movably in the divided state, so that the space for installing the device can be reduced in height. Further, the quake-absorbing device of the invention has the wiring opening for allowing the wiring cables to pass therethrough, which is formed substantially in the middle of the adjacent upper and lower support platforms, so that the wiring cables can effectively be arranged for connecting electronic devices or the like. Besides, the surrounding edge of the wiring opening defined by the upper and lower support platforms is covered with the protection member so as to prevent the wring cables from being damaged by the edge of the wiring opening. The upper support platform for carrying the protected object and the lower support platform secured on the floor are made of flat boards and provided with rails serving as reinforcing means, thus increasing the earthquake protection performance and the resistance to deformation under torsion.

According to the quake-absorbing device in the preferred modes for working the second invention, the plurality of quake-absorbing units constituting the quake-absorbing device of the invention are set in between the protected object and the floor around the wiring cables, so that the wiring cables can be arranged in the wiring passage defined by the quake-absorbing units and arranged for the protected object. Specifically, the quake-absorbing units can be retrofitted to the existing protected object.

Furthermore, the method for installing the quake-absorbing device in the preferred modes for working the second invention makes it possible to effectively install the divided quake-absorbing units to the protected object without interference from the wiring cables laid on the floor and to be connected to the protected object.

According to the quake-absorbing device in the preferred modes for working the third invention, the first rails are each formed of the paired rails overlapping in part with each other, so that the quake-absorbing device can be reduced in size by the overlapping length of the paired rails. Since the quake-absorbing device is reduced in size without shortening the first rails on which the second rollers 5 move rotatively, the sufficient lengths of the first rails can be assured to give a sufficient quake-absorbing performance. Thus, the quake-absorbing device can be applied to any protected objects independent of the configuration and size of the protected object without being restricted by the lengths of the first rails.

Moreover, since the quake-absorbing device in the preferred modes for working the third invention has the first rails overlapping in part to allow the second rollers to move rotatively within the overlapping length, so that the horizontal vibrations of an earthquake can be damped by the vibrational energy with respect to the movement of the rollers moving in the overlapping length so as to transmit the damped horizontal vibrations to the upper support platform, consequently to improve the quake-absorbing performance.

1-14. (Canceled)

15. A quake-absorbing device comprising an upper support platform, a lower support platform, curved rails disposed between said upper and lower support platforms, rollers movable along said rails, a plurality of quake-absorbing units arranged so as to form a wiring passage for wiring cables laid through a space defined vertically between a floor and a protected object raised from the floor, said quake-absorbing units each including a pair of first rails attached to said upper support platform and second rails arranged on said lower support platform perpendicularly to said first rails, first rollers movable rotatively along said first rails, second rollers movable rotatively along said second rails, and a column-like carriage movable in between said upper and lower support platforms, and wherein each of said first rails carries one of said first rollers, and said upper and lower support platforms each have short length for laying out said first rails and long length for laying out said second rail.

16. The quake-absorbing device according to claim 15, wherein two pairs of second rails and second rollers are mounted longitudinally on the carriage

17. The quake-absorbing device according to claim 15, wherein said upper and lower support platforms are joined to each other on their sides by means of connection members attached to the opposite sides of the quake-absorbing units.

18. The quake-absorbing device according to claim 15, wherein said wiring passage spreads on the side of the floor.

19. The quake-absorbing device according to claim 17, wherein said wiring passage spreads on the side of the floor.

20. The quake-absorbing device according to claim 18, wherein said upper support platform has a side W12 and said lower support platform has a side W14, said sides has a relation of W12>W14.

21. The quake-absorbing device according to claim 19, wherein said upper support platform has a side W12 and said lower support platform has a side W14, said sides has a relation of W12>W14.

22. The quake-absorbing device according to claim 15, wherein said first rollers disposed on said quake-absorbing units are joined to each other by means of roller connection members attached to the sides of said quake-absorbing units.

23. The quake-absorbing device according to claim 17, wherein said rollers disposed on said first quake-absorbing units are joined to each other by means of roller connection members attached to the sides of said quake-absorbing units.

24. The quake-absorbing device according to claim 18, wherein said rollers disposed on said first quake-absorbing units are joined to each other by means of roller connection members attached to the sides of said quake-absorbing units.

25. The quake-absorbing device according to claim 19, wherein said rollers first disposed on said quake-absorbing units are joined to each other by means of roller connection members attached to the sides of said quake-absorbing units.

26. The quake-absorbing device according to claim 22, wherein each roller connection member is held by a protrusion formed on said first roller.

27. The quake-absorbing device according to claim 23, wherein each roller connection member is held by a protrusion formed on said first roller.

28. The quake-absorbing device according to claim 25, wherein each roller connection member is held by a protrusion formed on said first roller.

29. (Canceled)

30. A method for installing the quake-absorbing device according to claim 15, comprising raising a protected object from a floor to form a space between said protected object and said floor for laying wiring cables therein, setting quake-absorbing units into said space around said wiring cables to assure a wiring passage between said quake-absorbing units set into said space, connecting said quake-absorbing units on their sides with

31-39. (Canceled)

40. A method for installing the quake-absorbing device according to claim 15, comprising arranging quake-absorbing units so as to form a wiring passage for wiring, connecting upper and lower support platforms on their one sides with connection members, and inserting said quake-absorbing units forming said wiring passage therebetween into between said upper and lower support platform from the other sides on which said upper and lower support platforms are not connected, connecting the not-connected sides of said upper and lower support platforms with connection members, and placing a protected object on said upper support platform.

41. The quake-absorbing device according to claim 16, wherein said upper and lower support platforms are joined to each other on their sides by means of connection members attached to the opposite sides of the quake-absorbing units.

42. The quake-absorbing device according to claim 16, wherein said wiring passage spreads on the side of the floor.

43. The quake-absorbing device according to claim 16, wherein said first rollers disposed on said quake-absorbing units are joined to each other by means of roller connection members attached to the sides of said quake-absorbing units.

44. The quake-absorbing device according to claim 20, wherein said rollers first disposed on said quake-absorbing units are joined to each other by means of roller connection members attached to the sides of said quake-absorbing units.

45. The quake-absorbing device according to claim 21, wherein said rollers first disposed on said quake-absorbing units are joined to each other by means of roller connection members attached to the sides of said quake-absorbing units.

46. The quake-absorbing device according to claim 24, wherein each roller connection member is held by a protrusion formed on said first roller.
